(19) United States
(12) Patent Application Publication
(10) Pub. No.: US 2002/0179377 A1
(43) Pub. Date: Dec. 5, 2002

(54) Vibration damping apparatus for elevator system

(75) Inventors: Junichi Higaki, Tokyo (JP); Yoshiaki Yamazaki, Tokyo (JP); Hisao Kuraoka, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha Tokyo, Japan

(21) Appl. No.: 09/951,462

(22) Filed: Sep. 14, 2001

(30) Foreign Application Priority Data
May 31, 2001 (JP) 2001-164913

(51) Int. Cl. B66B 1/34

(52) U.S. Cl. 187/292

(57) ABSTRACT

A vibration damping apparatus for an elevator system capable of reducing vibrations of an elevator car in the horizontal direction while preventing friction from occurring in driving mechanisms of an actuators. The apparatus includes magnetic actuators mounted fixedly on one of lower surface of a floor of an elevator car or a bottom member of a car supporting frame and corresponding magnetic pole members mounted on the other one. Vibration sensors are installed on the car floor or the bottom member of the car supporting frame. Detection signals of the sensors are inputted to a controller which responds thereto by controlling driving of the magnetic actuators so that vibration of the elevator car can be reduced.

### BACKGROUND OF THE INVENTION

1. Field of the Invention

The present invention generally relates to a vibration damping apparatus for an elevator system. More particularly, the present invention is concerned with a vibration damping apparatus designed for reducing or damping vibration of an elevator car or cab in the horizontal direction.

2. Description of Related Art

For better understanding of the concept underlying the present invention, description will first be made of a conventional vibration damping apparatus for an elevator system known heretofore by referring to the drawing. FIG. 25 is an elevational front-side view showing a hitherto known elevator equipped with a conventional vibration damping apparatus, which is disclosed, for example, in Japanese Patent Application Laid-Open Publication No. 319739/1993 (JP-A-5-319739). In FIG. 25, reference numeral 1 denotes an elevator car (also called lift cage or cab), numeral 2 denotes a car supporting frame for supporting the elevator car 1 through the medium of rubber vibration isolators 7 and 8 interposed between the elevator car 1 and the car supporting frame 2, numeral 10 generally denotes an elevator cage assembly which is comprised of the elevator car 1 and the car supporting frame 2, numeral 4 collectively denotes main ropes for suspending the car supporting Frame 2, numeral 3 denotes a pair of guide rails disposed on both sides of the elevator cage assembly 10 for guiding up/down movement of the car supporting frame 2 and hence the elevator car 1, and reference numeral 5 denotes guide rollers installed on the car supporting frame 2 through the medium of guide roller suspensions 5a and adapted to engage with the guide rails 3, respectively. The guide rollers 5 serve as rail followers for supporting the car supporting frame 2 in the course of up/down movement of the elevator cage assembly 10 at the left- and right-hand sides, as viewed in FIG. 25. In this conjunction, it should also be mentioned that another pair of guide rollers 5 are provided for supporting the car supporting frame 2 in the similar number at the front and rear sides as viewed in the figure.

Further, reference numeral 45 generally denotes a vibration damping apparatus disposed in the elevator cage assembly 10 for controlling and suppressing vibration of the elevator car 1 in the horizontal or transverse direction. As can be seen in the figure, the vibration damping apparatus 45 is comprised of a servomotor 48, a ball screw 48a directly coupled to the servomotor 48, a nut 48b rotatably mounted on the ball screw 48a and a thrust transfer mechanism 55 mounted on the nut 48b of the ball screw 48a. Further, reference numeral 56 denotes a car-supporting-frame/ball-screw clamp mounted on the car supporting frame 2 to serve for transmitting an axial force from the nut 48b to the car supporting frame 2 through the medium of the thrust transfer mechanism 55. Furthermore, numeral 57 denotes a ball screw support for supporting the ball screw 48a at one end thereof, numeral 58 denotes a vibration sensor installed on the floor of the elevator car 1, numeral 59 denotes a vibration sensor installed on the bottom member of the car supporting frame 2, numeral 60 denotes an encoder directly coupled to the rotor of the servomotor 48 for detecting the rotation thereof, numeral 61 denotes a controller for controlling the servomotor 48 on the basis of the information derived from the outputs of the vibration sensors 58 and 59, the encoder 60 and others. Further, numeral 49 denotes an actuator constituted by the servomotor 48, The ball screw 48a and the nut 48b Incidentally, the actuator 49 and the controller 61 cooperate to constitute a control means for suppressing controllably the vibration of The elevator cage or car 1 in the transverse or horizontal direction.

Next, description will be directed to the operation of the conventional vibration damping apparatus for the elevator system implemented in the structure described above. The guide rails 3 should ideally be so manufactured as to extend perfectly straightly. In actuality, however, it is extremely difficult or practically impossible to manufacture and lay out a rail having no joints in a length corresponding to the height of a tall or multistory building of concern. Besides, distortion or deformation may take place in the guide rail 3 and the multistory building itself due to aged deterioration. For the reasons mentioned above, the car supporting frame 2 and the elevator car 1 moving up/down or vertically at a high speed under the guidance of the guide rollers 5 running on and along the guide rails 3 is inevitably subjected to vibration in the horizontal direction. With a view to reducing such vibration in the horizontal direction, two the guide rollers or rail followers 5 provided pairwise at top and bottom positions, respectively, at both sides of the car supporting frame 2 are each supported by means of the guide roller suspension 5a interposed between the car supporting frame 2 and the guide rail 3. At this juncture, it should be added that other guide rollers and guide roller suspensions therefore (not shown) are also mounted at the front and rear sides of the car supporting frame 2 as viewed in FIG. 25 Incidentally, the vibration transmitted to the elevator car 1 from the car supporting frame 2 is damped or attenuated by means of the rubber vibration isolators 7 and 8 as well.

In the case of the elevator system designed to be operated at an ordinary up/down speed, it is possible to suppress the vibration transmitted to the elevator car 1 to a level within a range of 10 to 15 Gal at the least with the aid of the two sorts of vibration reducing or damping mechanisms (i.e., the guide roller suspensions 5a and the rubber vibration isolators 7 and 8). However, in general, in the case of the superhigh-speed elevator system installed in a tall building such as a skyscraper and operated at a very high speed in the order of 500 M/min or higher, great difficulty is encountered in suppressing the vibration to a target or desired level or less only with the aid of the above-mentioned vibration reducing mechanisms (5a; 7, 8). Such being the circumstances, there arises the necessity of installing the vibration damping apparatus 45 described above.

Now turning back to FIG. 25, when the vibration components which can not be suppressed with the two types of conventional vibration reducing mechanisms (5a; 7, 8) are applied to the elevator car 1, the vibration sensor 58 installed in the floor of the elevator car 1 detects the vibration of the floor of the elevator car 1. Additionally, the vibration sensor 59 installed similarly on the bottom member of the car supporting frame 2 detects the vibration of the car supporting frame 2. Acceleration or speed signal derived from the outputs of these vibration sensors 58 and 59 is inputted to the controller 61 together with the position or speed signal generated by the encoder 60 provided in association with the servomotor 48. On the basis of these input signals, the controller 61 generates a control command signal Tc for the servomotor 48. With the control command signal Tc, the actuator 49 is so driven as to reduce the vibration level of the floor of the elevator car 1. To this end, the control command signal Tc assumes such waveform which is inverted relative to the waveform of the acceleration or speed signal derived from the outputs of the vibration sensors 58 and 59. Thus, the rotor of the servomotor 48 mounted under the floor of the elevator car 1 is caused to rotate, whereby the ball screw 48a coupled to the rotor is caused to rotate. In this conjunction, it is noted that the nut 48b is fixedly secured to the car supporting frame 2 through the medium of the thrust transfer mechanism 55 and the car-supporting-frame/ball-screw clamp 56. Consequently, with the rotation of the servomotor 48, the elevator car 1 is caused to move relative to the car supporting frame 2 right and left or horizontally from side to side, as viewed in FIG. 25.

As mentioned previously, the elevator car 1 is elastically or resiliently supported in the car supporting frame 2 suspended by the main ropes 4 through the medium of the rubber vibration isolators 7 and 8. As a result, when the weight of the elevator car 1 changes due to increasing/decreasing of the load, e.g. the number of passengers, the relative position between the car supporting frame 2 and the elevator car 1 undergoes vibration in the vertical direction, which in turn brings about relative movement in the vertical direction between the servomotor 48 secured fixedly to the elevator car 1 and the car-supporting-frame/ball-screw clamp 56 fixedly mounted on the car supporting frame 2. Accordingly, in case the nut 48b and the car-supporting-frame/ball-screw clamp 56 are directly clamped, a load is applied to the ball screw 48a in the orthogonal direction due to the vertical up/down movement of the elevator car 1 brought about by increasing/decreasing of weight of the elevator car 1. At this juncture, it will easily be appreciated that application of external forces of other directions than the axial or longitudinal direction to the ball screw 48a is undesirable from the viewpoint of the stable operation and the use-life. Accordingly, the thrust transfer mechanism 55 which exhibits a high rigidity in the axial or longitudinal direction of the ball screw 48a and capable of freely moving in the direction orthogonal to the ball screw 48a is mounted between the nut 48b and the car-supporting-frame/ball-screw clamp 56 for the purpose of preventing the up/down or vertical movement mentioned above from being transmitted to the ball screw 48a. In this manner, the driving actuator 49 comprised of the servomotor 48, the ball screw 48a and others is implemented such that it can generate the force only in the axial or longitudinal direction of the ball screw 48a.

As can now be understood from the foregoing, the hitherto known vibration damping apparatus for the elevator system for reducing the vibration of the elevator car 1 in the horizontal direction includes as the driving source the actuator 49 which is composed of the servomotor 48, the ball screw 48a, the nut 48b, the car-supporting-frame/ball-screw clamp 56 and the thrust Transfer mechanism 55 and disposed within the space defined between the floor of the elevator car 1 and the bottom member of the car supporting frame 2, wherein the elevator car 1 is caused to move transversely (i.e., right and left as viewed in FIG. 25) relative to the car supporting frame 2 under the driving force of the transverse direction generated by the actuator 49 to thereby reduce the vibration of the elevator car 1 in the horizontal direction. In this conventional vibration damping apparatus, a frictional force makes appearance between the ball screw 48a and the nut 48b constituting parts of the force drive mechanism of the actuator 49. The direction of this frictional force is opposite to that of the driving force of the actuator 49. Thus, the conventional vibration damping apparatus for the elevator system suffers a problem that the control performance is likely to become instable, to a great disadvantage.

Furthermore, in the conventional vibration damping apparatus for the elevator system, temperature of the actuator 49 is caused to rise due to the friction in the driving mechanism of the actuator 49, which gives rise to problems that the performance of the actuator system becomes unstable and that the kinetic energy of the actuator can not efficiently be utilized.

Besides, in the conventional vibration damping apparatus for the elevator system, abrasion of the parts constituting the driving mechanism of the servomotor is inevitable under the action of the friction mentioned previously, which makes the use-life of the constituent parts of the driving mechanism be shortened, rendering it necessary to periodically inspect and/or replace the constituent parts, involving overhead in respect to the maintenance.

In addition, the conventional vibration damping apparatus for the elevator system which is designed for reducing the vibration of the elevator car 1 in the horizontal direction suffers a problem that when the elevator car 1 is subjected to a significant external disturbance, the rotational stroke of the servomotor 48 increases in order to suppress the vibration brought about by the external disturbance. As a consequence, there may unwantedly occur such situation that the thrust transfer mechanism 55 and the ball screw support 57 move closely to each other until collision takes place therebetween. Similar unwanted events may also take place between the servomotor 48 and the nut 48b.

Moreover, when the initial positions of the individual constituent parts or members of the driving mechanism of the actuator are deviated to right or left relative to the elevator car 1 due to failure and aged deterioration of the controller 61, collision may unwantedly take place between the car-supporting-frame/ball-screw clamp 56 and the ball screw support 57 or between the servomotor 48 and the nut 48b. In that case, impact force makes appearance between the elevator car 1 and the car supporting frame 2, which will not only give uncomfortableness to the passenger(s) but also involve trouble in the operation of the elevator system.

Finally, it should also be added that collision between the car-supporting-frame/ball-screw clamp 56 and the ball screw support 57 or between the servomotor 48 and the nut 48b will give rise to deformation of the constituent parts, shortening the use-life of the elevator control system inclusive of the vibration damping apparatus or bringing about malfunction or shutdown thereof in the worst case.

### SUMMARY OF THE INVENTION

In the light of the state of the art described above, it is an object of the present invention to provide a vibration damping apparatus for an elevator system which can enjoy an extended use-life, enhanced reliability and improved control performance by preventing the friction from occurring in the driving mechanism of the actuator while reducing the impact force by avoiding inter-part collision in the driving mechanism of the actuator means.

In view of the above and other objects which will become apparent as the description proceeds, there is provided according to a general aspect of the present invention a vibration damping apparatus for an elevator system which includes an elevator car and a car supporting frame for supporting the elevator car through the medium of vibration isolation means interposed between the elevator car and the car supporting frame. The vibration damping apparatus mentioned above includes a magnetic actuator means disposed within a space defined between a floor of the elevator car and a bottom member of the car supporting frame and fixedly secured to either one of the elevator car or the car supporting frame, a magnetic pole means disposed within the above-mentioned space and fixedly secured to the other of the elevator car and the car supporting frame and disposed in opposition to the magnetic actuator means so that a magnetic attracting force is generated in a horizontal direction between the magnetic actuator means and the magnetic pole means when a driving current is fed to the magnetic actuator means, a vibration sensor means for detecting vibration of the floor of the elevator car in the horizontal direction, and a controller means for fetching a detection signal of the vibration sensor means as an input signal to thereby control driving of the magnetic actuator means such that vibration of the elevator car in the horizontal direction is thereby reduced.

By virtue of the structure of the vibration damping apparatus described above, occurrence of friction as well as abrasion of the constituent parts or components of the apparatus can positively be prevented because of non-contacting or contactless arrangement thereof. Thus, the magnetic actuator is protected against degradation of the operation performance which will otherwise be brought about by aged deterioration In other words, the vibration damping apparatus capable of damping vibration of the elevator car in the horizontal direction with improved control characteristics and high reliability while mitigating burden of maintenance is provided for the elevator system which can be operated at a very high speed.

According to another aspect of the present invention, there is provided a vibration damping apparatus for an elevator system which includes an elevator car and a car supporting frame for supporting the elevator car through the medium of vibration isolation means interposed between the elevator car and the car supporting frame, wherein an upper space is defined between a ceiling of the elevator car and a mop member of the car supporting frame while a lower space is defined between a floor of the elevator car and a bottom member of the car supporting frame. The vibration damping apparatus mentioned above comprises a magnetic actuator means disposed within the upper and lower spaces, respectively, and fixedly secured to either one of the elevator car or the car supporting frame, magnetic pole means disposed within the upper and lower spaces, respectively, and fixedly secured to the other of the elevator car and the car supporting frame and disposed in opposition to the magnetic actuator means, respectively, so that magnetic attracting forces are generated in a horizontal direction between the magnetic actuator means and the magnetic pole means, respectively, when driving currents are fed to the actuator means, respectively, vibration sensor means for detecting vibrations of the floor and the ceiling, respectively, of the elevator car in the horizontal direction, and a controller means for fetching detection signals of the vibration sensor means as input signals, respectively, to thereby control driving of the magnetic actuator means such that vibration of the elevator car in the horizontal direction is thereby reduced.

In the vibration damping apparatus described above, the magnetic actuator means, the magnetic pole means and the vibration sensor means are provided each in a pair in the upper and lower spaces, respectively, which are defined between the elevator car and the car supporting frame. By virtue of this structure, the vibration of the elevator car in the horizontal direction can be suppressed more positively without bringing about rotation or revolution of the elevator car.

In a preferred mode for carrying out the present invention, the magnetic actuator means may be constituted by a magnetic attraction type actuator designed for generating an electromagnetic attracting force.

Owing to the feature mentioned above, the vibration damping apparatus which operates in a contactless manner without giving rise to friction and abrasion can easily be realized.

In another preferred mode for carrying out the present invention, a cushioning means may be disposed between the magnetic actuator and the magnetic pole means.

With the structure of the vibration damping apparatus described above, direct contact between the core of the magnetic attraction type actuator and the magnetic pole means which may otherwise occur upon positional deviation of the constituent parts from the initial positions due to malfunction of the controller means and/or the aged-deterioration can be avoided. Besides, impact force can be absorbed by the cushioning means. Thus, the up/down operation of the elevator car can be carried out with safety without giving uncomfortableness to the passengers.

In yet another preferred mode for carrying out the present invention, the cushioning means may be disposed on an end face of the magnetic pole means which faces in opposition to the magnetic attraction type actuator.

Owing to the feature mentioned above, the cushioning means can easily be mounted with high reliability.

In still another preferred mode for carrying our the present invention, the cushioning means may be disposed on an attracting end face of a coil-wound core of the magnetic attraction type actuator which face is disposed in opposition to the magnetic pole means.

With the arrangement mentioned above, the cushioning means can easily be mounted while ensuring the intended action and effect thereof.

In a further preferred mode for carrying our the present invention, the actuator means may include a plurality of magnetic attraction type actuators which are so combined with one another that forces can be generated along two translation axes and around one rotation axis, respectively.

With the arrangement of the magnetic attraction type actuators described above, vibrations of the elevator car can be reduced more effectively.

In a yet further preferred mode for carrying out the present invention, the magnetic actuator means includes a plurality of magnetic attraction type actuators which are combined pairwise in sets oriented orthogonally to each other so that a couple of forces can be generated around a center of suspension of the car supporting frame, whereby forces can be generated along two translation axes and around one rotation axis, respectively.

With the arrangement of the magnetic attraction type actuators described above, there can be realized the vibration damping apparatus with a less number of parts at low manufacturing cost.

In a still further preferred mode for carrying out the present invention, the controller means may be so designed as to fetch as input signals thereto a detection signal of a displacement sensor means designed for measuring a gap between a coil-wound core of the magnetic attraction type actuator and the magnetic pole means together with a detection signal of the vibration sensor to thereby generate a control signal for driving the magnetic attraction type actuator.

With the arrangement described above, the characteristics of the magnetic attraction type actuator can be optimized. Thus, there can be realized the vibration damping apparatus which exhibits improved control characteristics and performance.

In a mode for carrying out the present invention, the magnetic attraction type actuator should preferably be so designed as to include coils wound around an annular iron core and magnetically attract the magnetic pole means disposed in opposition to the coils upon electrical energization thereof.

With the arrangement described above, the vibration damping apparatus can be implemented in a much simplified structure which allows the apparatus to be easily installed. Thus, there is provided for the elevator system the vibration damping apparatus realized inexpensively while ensuring high reliability and easy maintenance.

In another mode for carrying out the present invention, the displacement sensor means should preferably be so fixedly secured to the magnetic attraction type actuator as to present a reference face positioned in a same plane as an attracting end face of a coil-wound core of the magnetic attraction type actuator.

With the arrangement described above, the value derived by arithmetically processing the output of the displacement sensor means and the actual gap intervening between the magnetic attraction actuator and the magnetic pole member coincide with each other with high accuracy, as a result of which the vibration suppression control can be performed with high effectiveness. Further, the assembling of the vibration damping apparatus can be facilitated because what is required is only to align the end face of the magnetic attraction actuator with that of the displacement sensor means. Thus, there is provided the vibration damping apparatus which can be manufactured at low cost while ensuring enhanced performance.

In yet another mode for carrying out the present invention, the displacement sensor means should preferably be so fixedly secured to the magnetic pole means as to present a reference face positioned in a same plane as an end face of the magnetic pole means which is disposed in opposition to the magnetic attraction type actuator.

With the arrangement described above, the value obtained by processing the output of the displacement sensor means and the actual gap intervening between the magnetic attraction actuator and the magnetic pole member coincide with each other with high accuracy, as a result of which the vibration suppression control can be performed with high effectiveness Further, the assembling of the vibration damping apparatus can be facilitated because what is required is only to align the end face of the magnetic pole means with that of the displacement sensor means. Thus, there is provided the vibration damping apparatus which can be manufactured at low cost while ensuring enhanced performance.

According to yet another aspect of the present invention, there is provided a vibration damping apparatus for an elevator system which includes an elevator car and a car supporting frame for supporting the elevator car through the medium of vibration isolation means interposed between the elevator car and the car supporting frame, wherein a space is defined between a floor of the elevator car and a bottom member of the car supporting frame. The vibration damping apparatus mentioned above includes an actuator means comprised of plural pairs of magnetic actuators disposed within the space, each of the magnetic actuators being designed to generate selectively a magnetic attracting force or a magnetic repulsive force, wherein ones of the paired magnetic actuators being fixedly secured to either one of the elevator car or the car supporting frame while the others of the paired magnetic actuators are fixedly secured to the other of the elevator car and the car supporting frame, the magnetic actuators in each of the pairs being disposed in opposition to each other, vibration sensor means for detecting vibration of the floor of the elevator car in horizontal direction, and a controller means for fetching a detection signal of the vibration sensor means as an input signal to thereby selectively control driving of the pairs of actuator means such that vibration of the elevator car in the horizontal direction can thereby be reduced.

By virtue of the structure of the vibration damping apparatus described above, occurrence of friction as well as abrasion of the constituent parts or components of the vibration damping apparatus can positively be prevented because of non-contacting or contactless arrangement thereof. Thus, the magnetic actuator is protected against change or variation of the operation performance due to the aged deterioration. In other words, the vibration damping apparatus which is capable of effectively suppressing the vibration of the elevator car in the horizontal direction with improved control characteristics and high reliability while mitigating burden of maintenance is provided for the elevator system which is designed to be operated at a very high speed.

In a mode for carrying out the present invention, vibration isolation means should preferably be disposed between the magnetic attraction type actuator and the magnetic pole means.

With the arrangement mentioned above, the cushioning means and the magnetic attraction type actuator can be installed at a same place, whereby the space for installing the apparatus can correspondingly be saved. Besides, the vibration damping apparatus can be assembled with high accuracy, ensuring enhanced operation performance.

In another preferred mode for carrying out the present invention, there should further be provided an elevator operation controller which is designed to perform up/down operation of the elevator car at a low speed or stop the up/down operation of the elevator car when an output value of the vibration sensor exceeds a range of predetermined values.

With the arrangement described above, operation of the elevator system can be carried out with safety simply by deciding whether the level of the vibration sensor and/or the displacement sensor exceeds the range of the predetermined values.

In yet another preferred mode for carrying out the present invention, there should further be provided an elevator operation controller which informs an elevator maintenance/inspection facility of occurrence of abnormality when an output value of the vibration sensor exceeds a range of predetermined values.

With the arrangement described above, abnormality, if occurred, can instantaneously be informed to the elevator maintenance/inspection facility for inspecting and repairing the elevator system speedily. Thus, the safety of the vibration damping apparatus as well as the elevator system can further be enhanced.

In still another preferred mode for carrying out the present invention, there should be provided a sensor output processing controller means which is designed to carry out up/down operation of the elevator car at a low speed once or several times for detecting and storing rail curvature(s) on the basis of output of the vibration sensor, and in an ordinary operation mode, the controller means should preferably drive the actuator means by taking into account the stored rail curvature(s).

With the arrangement of the vibration damping apparatus described above, a so-called feed-forward control can be realized for preventing generation of vibration of the elevator car notwithstanding of remarkable curvatures of the guide rails. Furthermore, much comfortableness can be assured for the passengers in the ultrahigh-speed operation of the elevator system.

According to still another aspect of the present invention, there is provided a vibration damping apparatus for an elevator system which includes an elevator car and guide rails disposed at both sides, respectively, of the elevator car. The vibration damping apparatus includes magnetic guide means composed of a set of magnetic attraction type actuators for holding the elevator car in a non-contacting or contactless state by generating magnetic attracting forces to the guide rails, respectively, displacement sensor means for detecting positional displacements or deviations of the guide rails, and controller means for fetching as input signals thereto detection signals derived from outputs of the displacement sensor means to thereby generate control signals to the set of magnetic attraction type actuators for thereby reducing vibration of the elevator car in horizontal direction.

In the elevator system equipped with the vibration damping apparatus described above, inexpensive guide rails of low dimensional precision can be used, and comfortableness can nevertheless be assured even in the ultrahigh-speed operation of the elevator system.

According to a further aspect of the present invention, there is provided an elevator system which includes an elevator car and a car supporting frame for supporting the elevator car through the medium of vibration isolation means interposed between the elevator car and the car supporting frame. The elevator system includes magnetic actuator means disposed within a space defined between a floor of the elevator car and a bottom member of the car supporting frame and fixedly secured to either one of the elevator car or the car supporting frame, magnetic pole means disposed within the space and fixedly secured to the other one of the elevator car and the car supporting frame and disposed in opposition to the magnetic actuator means so that a magnetic attracting force is generated in a horizontal direction between the magnetic actuator means and The magnetic pole means when a driving current is fed to the magnetic actuator means, vibration sensor means for detecting vibration of the floor of the elevator car In the horizontal direction, guide rails disposed at lateral sides of the car supporting frame for guiding up/down movement of the car supporting frame and the elevator car, magnetic guide means including a set of magnetic attraction type actuators for holding the car supporting frame in a contactless state by generating magnetic attracting forces to the guide rails, displacement sensor means for detecting positional displacements or deviations of the guide rails, and controller means for fetching as input signals thereto detection signals derived from outputs of the vibration sensor means and the displacement sensor means to thereby generate control signals to the magnetic actuation means and the magnetic guide means for thereby reducing vibration of the elevator car in horizontal direction.

By virtue of the structure of the elevator system described above, vibration of the elevator car can be suppressed more positively through cooperation of the magnetic actuator means and the magnetic guide means, whereby much enhanced comfortableness can be assured for the passenger. Besides, even in the case where one of the magnetic actuator means and The magnetic guide means should suffer malfunction or some failure, it is possible to suppress the vibration of the elevator car by the other means.

In another preferred mode for carrying out the present invention, the guide rail may be of a V- or T-like cross section.

By using the guide rail having the V- or T-like cross section, the manufacturing cost can further be reduced.

The above and other objects, features and attendant advantages of the present invention will more easily be understood by reading the following description of the preferred embodiments thereof taken, only by way of example, in conjunction with the accompanying drawings.

### BRIEF DESCRIPTION OF THE DRAWINGS

In the course of the description which follows, reference is made to the drawings, in which:

FIG. 1 is an elevational front-side view of an elevator system incorporating a vibration damping apparatus according to a first embodiment of the present invention;

FIG. 2 is a block diagram showing generally and schematically a control system incorporated in the vibration damping apparatus for the elevator system according to the first embodiment of the present invention;

FIG. 3 is a bottom plan view of an elevator system equipped with a vibration damping apparatus according to a second embodiment of the present invention;

FIG. 4 is a bottom plan view of an elevator system equipped with a vibration damping apparatus according to a third embodiment of the present invention;

FIG. 5 is a bottom plan view of an elevator system equipped with a vibration damping apparatus according to a fourth embodiment of the present invention;

FIG. 6 is a block diagram for illustrating generally and schematically a method of driving the vibration damping apparatus according to the fourth embodiment of the present invention;

FIG. 7 is an elevational front-side view of an elevator system equipped with a vibration damping apparatus according to a fifth embodiment of the present invention;

FIG. 8 is a bottom plan view of an elevator system equipped with a vibration damping apparatus according to a sixth embodiment of the present invention;

FIG. 9 is a bottom plan view of an elevator system equipped with a vibration damping apparatus according to a seventh embodiment of the present invention;

FIG. 10 is a perspective view of an elevator system equipped with a vibration damping apparatus according to an eighth embodiment of the present invention;

FIG. 11 is an enlarged fragmental perspective view of a portion indicated as enclosed by a broken line circle A in FIG. 10;

FIG. 12 is an enlarged fragmental perspective view of a portion indicated as enclosed by a broken line circle B in FIG. 10;

FIG. 13 is a perspective view showing schematically an elevator system equipped with a vibration damping apparatus according to a ninth embodiment of the present invention;

FIG. 14 is an enlarged fragmental perspective view of a portion indicated as enclosed by a broken line circle C in FIG. 13;

FIG. 15 is an enlarged fragmental perspective view of a portion indicated as enclosed by a broken line circle D in FIG. 13;

FIG. 16 is an elevational front-side view showing an vibration damping apparatus for an elevator system according to a tenth embodiment of the present invention;

FIG. 17 is a bottom plan view showing schematically an vibration damping apparatus including a magnetic attraction type actuator, a magnetic pole member and a cushioning pad, as viewed in the direction indicated by an arrow A in FIG. 16;

FIG. 18 is a bottom plan view of a vibration damping apparatus including a magnetic attraction type actuator, a magnetic pole member and a cushioning pad according to an eleventh embodiment of the present invention;

FIG. 19 is a bottom plan view of a vibration damping apparatus including a magnetic attraction type actuator, a magnetic pole member and a cushioning pad according to a twelfth embodiment of the present invention;

FIG. 20 is a bottom plan view of a vibration damping apparatus including a magnetic attraction type actuator, a magnetic pole member and a displacement sensor according to a thirteenth embodiment of the present invention;

FIG. 21 is a bottom plan view of a vibration damping apparatus including a magnetic attraction type actuator, a magnetic pole member and a displacement sensor according to a fourteenth embodiment of the present invention;

FIG. 22 is an elevational front-side view showing a structure of a vibration damping apparatus for an elevator system according to a fifteenth embodiment of the present invention;

FIG. 23 is a flow chart for illustrating operation of an elevator system equipped with the vibration damping apparatus according to a sixteenth embodiment of the present invention;

FIG. 24 is a flow chart for illustrating operation of an elevator system equipped with the vibration damping apparatus according to a seventeenth embodiment of the present invention; and

FIG. 25 is an elevational front-side view showing a hitherto known elevator system equipped with a conventional vibration damping apparatus.

### DESCRIPTION OF THE PREFERRED EMBODIMENTS

The present invention will be described in detail in conjunction with what is presently considered as preferred or typical embodiments thereof by reference to the drawings. In the following description, like reference characters designate like or corresponding parts throughout the several views. Also in the following description, it is to be understood that such terms as “left”, “right”, “front”, “rear” and the like are words of convenience and are not to be construed as limiting terms.

Embodiment 1

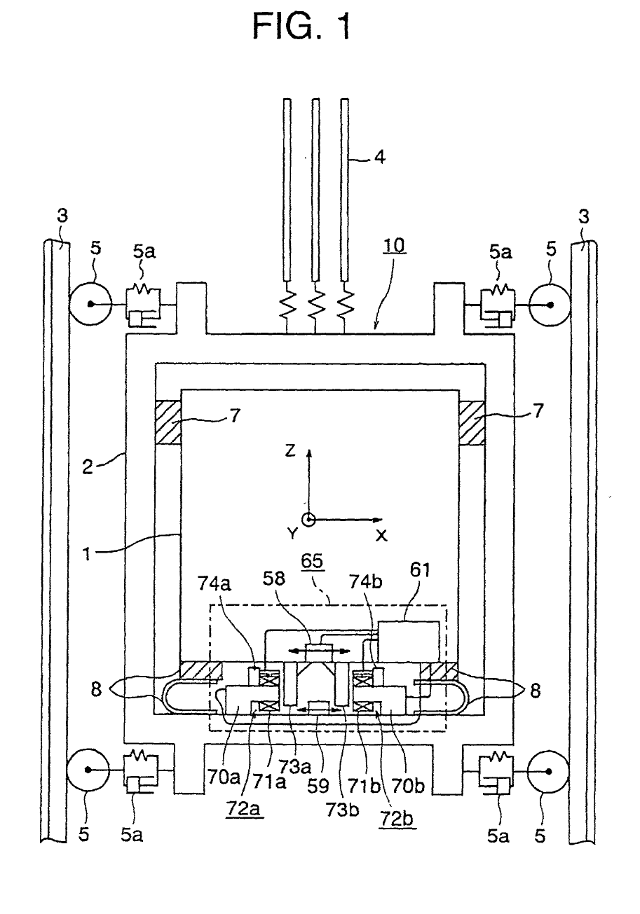

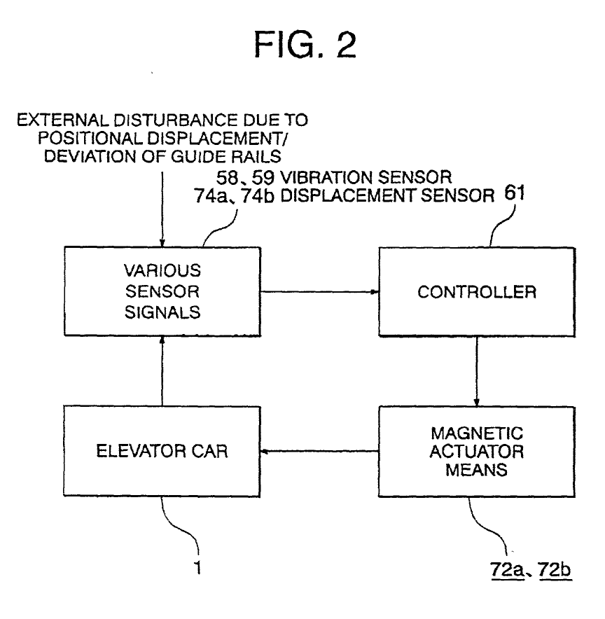

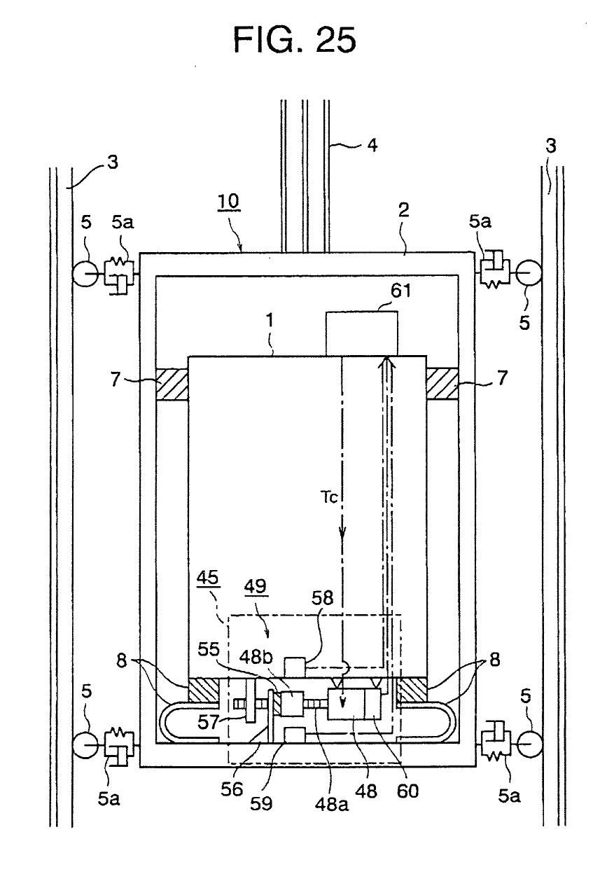

Now, description will be made in detail of the vibration damping apparatus for the elevator system according to a first embodiment of the present invention by reference to FIGS. 1 and 2, wherein FIG. 1 is an elevational front-side view of an elevator system for illustrating the vibration damping apparatus, and FIG. 2 is a block diagram showing generally and schematically a control system incorporated in the vibration damping apparatus for the elevator system. Incidentally, components same as or equivalent to those of the conventional vibration damping apparatus for the elevator system described hereinbefore by reference to FIG. 25 are denoted by like reference symbols and repeated description will be omitted.

Referring to FIG. 1, the vibration damping apparatus 65 according to the first embodiment of the invention differs from the conventional vibration damping apparatus 45 described hereinbefore by reference to FIG. 25 in the respects that magnetic actuators 72a and 72b are provided which are constituted, respectively, by iron cores 70a and 70b fixedly mounted on a bottom member of the car supporting frame 2, facing in opposition to each other and coils 71a and 71b wound around the iron cores 70a and 70b, respectively, and that attracting magnetic pole members 73a and 73b are disposed under the floor of the elevator car (i-e., mounted fixedly on the lower surface of the floor of the elevator car) in opposition to the magnetic actuators 72a and 72b, respectively, wherein the magnetic pole members 73a and 73b are each formed of a magnetic material so as to be magnetically attracted by the magnetic actuators. Incidentally, the magnetic actuators constitute “magnetic actuator means”, while the magnetic pole members constitute “magnetic pole means”. Furthermore, there are provided displacement sensors 74a and 74b, wherein the displacement sensor 74a is designed to measure the positional deviation or displacement or gap distance intervening between the tip end (end face) of the iron core 70a and the magnetic pole member 73a, while the displacement sensor 74b is designed to measure the positional displacement or gap distance between the tip end of the iron core 70b and the magnetic pole member 73b. Parenthetically, the displacement sensors mentioned above constitute “displacement sensor means”. In other respects, The structure shown in FIG. 1 is substantially similar to that shown in FIG. 25. Thus, reference numeral 58 denotes a vibration sensor installed on a floor of the elevator car 1, denotes a vibration sensor installed on the bottom member of the car supporting frame 2, and reference numeral 61 denotes a controller to which the signals derived from the outputs of the vibration sensors 58 and 59 are inputted and which is designed or programmed to issue a control command signal to the magnetic actuator 72a; 72b. Incidentally, the vibration sensors mentioned above constitute “vibration sensor means”. At this juncture, it should be added that the magnetic actuator 72a, the magnetic pole member 73a and the displacement sensor 74a on one hand and the magnetic actuator 72b, the magnetic pole member 73b and the displacement sensor 74b on the other hand are implemented in mutually same structures, respectively, and mounted symmetrically to each other.

Next, description will be directed to the operation of the vibration damping apparatus for the elevator system. When the superhigh-speed elevator system to which the instant embodiment of the invention is applied is operated at the speed of 500 M/min or higher, the vibration components which can not be mitigated by means of the vibration reducing mechanisms such as the guide roller suspensions 5a and the rubber vibration isolators 7 and 8 will take place in the horizontal direction of the elevator car 1 under the influence of the joints or seams and/or curvatures of the guide rails 3. The vibration damping apparatus 65 is installed with a view to reducing these vibration components.

More specifically, when the vibration components which cannot be reduced by the conventional vibration reducing mechanisms such as the guide roller suspensions 5a and the rubber vibration isolators 7 and 8 take place in the horizontal direction of the elevator car 1, the vibration sensor 58 installed at the floor of the elevator car 1 then detects the vibration of the floor of the elevator car 1. Additionally, the vibration sensor 59 installed on the bottom member of the car supporting frame 2 detects the vibration of the car supporting frame 2 The acceleration or speed signals arithmetically derived from the outputs of these vibration sensors 58 and 59 as well as the displacement signals outputted from the displacement sensors 74a and 74b are inputted to the controller 61 which then responds thereto by issuing the control command signal Tc for the magnetic actuators 72a and 72b. As a result of this, the magnetic actuators 72a and 72b are so driven in response to the control command signal Tc that the vibration magnitude or level of the floor of the elevator car 1 is reduced or the elevator car 1 is moved or displaced relative to the car supporting frame 2 in the direction in which the vibration of the floor of the elevator car 1 can be canceled out, to say in another way. For driving the magnetic actuator 72a; 72b, a driving current is fed to the coil 71a; 71b wound around the iron core 70a; 70b to thereby generate a magnetic attracting force for magnetically the magnetic pole member 73a; 73b. Since the magnetic pole member 73a; 73b is mounted under the floor of the elevator car 1, the latter is caused to move to left or right relative to the car supporting frame 2 upon generation of the attracting force, as viewed in the figure.

FIG. 2 is a block diagram for illustrating the operation described above. Referring to the figure, external disturbance brought about by the positional displacement or deviation of the guide rails 3 is detected by the vibration sensors 58 and 59 and the displacement sensors 74a and 74b. The output signals of these sensors are supplied to the controller 61 as the input signals thereto. The controller 61 responds to these signals by issuing the control command signal Tc for the magnetic actuators 72a and 72b so that the vibration of the elevator cage assembly 10 is damped or attenuated.

Parenthetically, the information derived from the displacement sensor 74a; 74b contains information concerning deviation brought about due to nonlinearity of the driving force generated by the magnetic actuator 72a; 72b in addition to the disturbance information due to the positional displacement or distortion of the guide rail 3. Thus, it can be said that the displacement sensor 74a; 74b serves not only as the gap sensor for detecting the external disturbance due to the positional deviation or displacement of the guide rail 3 but also for the function for compensating for the nonlinearity of the driving force of the magnetic actuator 72a; 72b.

By the way, the elevator car 1 is resiliently supported on the car supporting frame 2 by leans of the rubber vibration isolators 7 and 8, and the car supporting frame in turn is suspended by the main ropes 4. Consequently, the relative position between the car supporting frame 2 and the elevator car 1 changes vibratingly in the vertical direction where the load imposed on the elevator car 1 changes due to change of the number of the passengers. As a result of this, the magnetic actuators 72a and 72b fixedly mounted on the elevator car 1 undergo positional displacement in the vertical direction relative to the magnetic pole members 73a and 73b which are fixedly mounted on the car supporting frame 2 However, the gap distance between the magnetic actuator 72a; 72b and the magnetic pole member 73a; 73b remains unchanged. Besides, no friction can occur owing to the non-contacting or contactless configuration of the magnetic vibration damping apparatus. Thus, the performance of the magnetic actuator 72a; 72b can be protected against the influence of change of the payload of the elevator car 1 due to the increase/decrease of the number of the passengers.

Embodiment 2

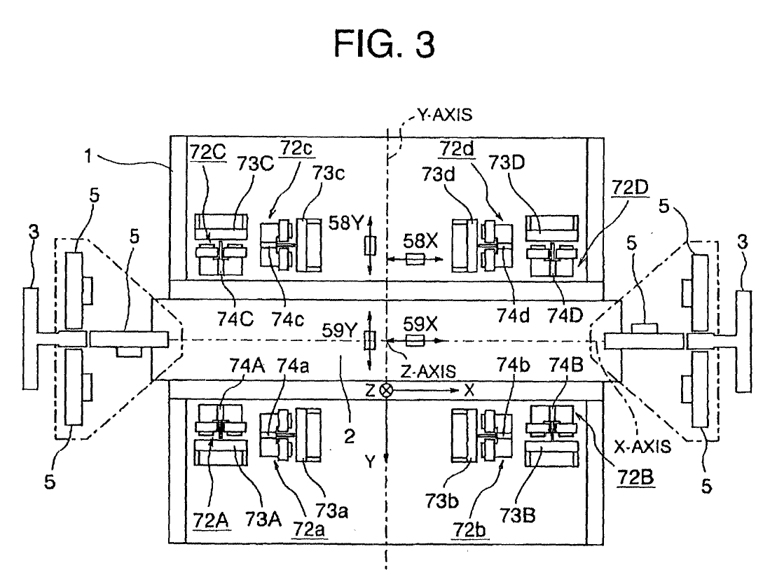

Next, the vibration damping apparatus for the elevator system according to a second embodiment of the present invention will be described by reference to FIG. 3 which is a bottom plan view of an elevator system equipped with the vibration damping apparatus according to the second embodiment of the invention. Incidentally, in FIG. 3, components or parts same as or equivalent to those mentioned hereinbefore in conjunction with the conventional apparatus and the first embodiment are denoted by like reference symbols and repeated description will be omitted.

According to the teachings of the present invention incarnated in the instant embodiment, eight vibration damping units each composed of the magnetic actuators, the magnetic pole members and the displacement sensors arranged in the essentially same manner as described previously in conjunction with the first embodiment are disposed within the space defined between the floor of the elevator car 1 and the bottom member of the car supporting frame 2 in four areas divided by the X-axis (line interconnecting the center points of the guide rails 3, respectively) and the Y-axis (represented by the centerline of the elevator car 1 extending in the horizontal direction as viewed orthogonally to the plane of FIG. 3) symmetrically to both the X-axis and the Y-axis, as shown in FIG. 3.

In FIG. 3, reference symbol 58X denotes a vibration sensor installed on the floor of the elevator car 1 for detecting the vibration in the X-direction, 58Y denotes a vibration sensor installed on the floor of the elevator car 1 for detecting the vibration in the Y-direction, 59X denotes a vibration sensor installed on the car supporting frame 2 for detecting the vibration in the X-direction, and 59Y denotes a vibration sensor installed on the car supporting frame 2 for detecting the vibration in the Y-direction, wherein these vibration sensors are mounted in the similar manner as described previously in conjunction with the first embodiment of the invention. Further, reference symbols 72a and 72c denote, respectively, magnetic actuators producing the magnetic attracting forces for the magnetic pole members 73a and 73c, respectively, which are mounted on the elevator car 1 for thereby generating the driving forces in the (−)X-direction, and 72b and 72d denote, respectively, magnetic actuators producing the magnetic attracting forces for the magnetic pole members 73b and 73d, respectively, which are mounted under the floor of the elevator car 1 for thereby generating the driving forces in the (+)X-direction, wherein the magnetic actuators 72a, 72b, 72c and 72d mentioned above are all mounted on the bottom member of the car supporting frame 2 in the similar manner as described hereinbefore in conjunction with the first embodiment of the invention. Similarly, reference numerals 72A and 72B denote, respectively, magnetic actuators producing the magnetic attracting forces for the magnetic pole members 73A and 73B, respectively, which are mounted on the elevator car 1 for thereby generating the driving forces in the (−)Y-direction, and 72C and 72D denote, respectively, magnetic actuators producing the magnetic attracting forces for the magnetic pole members 73C and 73D, respectively, which are mounted on the elevator car 1 for thereby generating the driving forces in the (+)Y-direction of the elevator car 1, wherein the magnetic actuators 72A, 72B, 72C and 72D mentioned above are all mounted on the bottom member of the car supporting frame 2 in the similar manner as described hereinbefore in conjunction with the first embodiment of the invention.

Furthermore, reference numerals 74a, 74b, 74c and 74d denote, respectively, the displacement sensors designed for measuring the gap distances between the tip end portions (end faces) of the individual iron cores of the magnetic actuators 72a, 72b, 72c and 72d and the magnetic pole members 73a, 73b, 73c and 73d, respectively, while reference numerals 74A, 74B, 74C and 74D denote, respectively, the displacement sensors which are designed for measuring the gap distances between the tip end portions (end faces) of the individual iron cores of the magnetic actuators 72A, 72B, 72C and 72D and the magnetic pole members 73A, 73B, 73C and 73D, respectively.

In the vibration damping apparatus implemented in the structure described above, the vibration components which make appearance in the X-direction of the elevator car 1 when the elevator is operated at a very high speed or superhigh-speed and which can not be damped with the conventional vibration reducing mechanisms such as The guide roller suspensions 5a, the rubber vibration isolators 7 and 8 and others can be reduced through the process described previously in conjunction with the first embodiment of the invention. More specifically, the vibration sensor 58X detects the vibration of the floor of the elevator car 1 in the X-direction, while the vibration sensor 59X detects the vibration of the bottom member of the car supporting frame 2 in the X-direction. The acceleration or speed signals derived from the outputs of these vibration sensors 58X and 59X are supplied to the controller 61 together with the displacement signals derived from the outputs of the displacement sensors 74a, 74b, 74c and 74d. On the basis of these input signals, the controller 61 generates the control command signal Tc for driving selectively the magnetic actuators 72a, 72b, 72c and 72d so that the level or magnitude of vibration of the floor of the elevator car 1 may be suppressed. By way of example, when the elevator car 1 is to be moved in the (−)X-direction, the driving force is generated through cooperation of the magnetic actuators 72a and 72c, whereas when the elevator car 1 is to be moved in the (+)X-direction, the driving force is generated through cooperation of the magnetic actuators 72b and 72d. Owing to the driving forces generated in this way, the elevator car 1 and the car supporting frame 2 are moved to right or left relative to each other, as viewed in the plane of FIG. 3, whereby the vibration of the elevator car 1 in the X-direction can be reduced.

Further, when the vibration generates in the Y-direction of the elevator car 1, it can similarly be suppressed, as described above. More specifically, the vibration sensor 58Y detects the vibration of the floor of the elevator car 1 in the Y-direction, while the vibration sensor 59Y detects the vibration of the bottom member of the car supporting frame 2 in the Y-direction. The acceleration or speed signals derived from the outputs of these Y-direction vibration sensors 5BY and 59Y are supplied to the controller 61 together with the displacement signals derived from the outputs of the displacement sensors 74A, 74B, 74C and 74D as input signals. On the basis of these input signals, the controller 61 generates the control command signal Tc for driving selectively the magnetic actuators 72A, 723, 72C and 72D so that the level or magnitude of vibration of the floor of the elevator car 1 can be reduced. By way of example, when the elevator car 1 is to be moved in the (−)Y-direction, the driving force is generated through cooperation of the magnetic actuators 72A and 72B, whereas when the elevator car 1 is to be moved in the (+)Y-direction, the driving force is generated through cooperation of the magnetic actuators 72C and 72D. Owing to the driving force generated-in this way, the elevator car 1 can be moved frontward or backward (to the top or bottom as viewed in FIG. 3) relative to the car supporting frame 2, whereby the vibration of the elevator car 1 in the Y-direction can be attenuated.

Furthermore, rotational vibration of the elevator car 1 taking place around the Z-axis of the car 1 can also be reduced through appropriate combinatorial cooperation of the vibration sensors 58X, 59X, 58Y and 59Y, the displacement sensors 74a, 74b, 74c and 74d, the magnetic actuators 72a, 72b, 72c and 72d and the magnetic pole members 73a, 73b, 73c and 73d. By way of example, when the elevator car 1 is to be moved in-the clockwise direction as viewed in FIG. 3 (i-e., plus-rotational direction) around the Z-axis, the driving force is generated through cooperation of the magnetic actuators 72a and 72d, whereas when the elevator car 1 is to be moved in the counterclockwise direction as viewed in FIG. 3 (i.e., minus-rotational direction) with reference to the Z-axis, the driving force is generated through cooperation of the magnetic actuators 72b and 72c which are disposed on the diagonal line extending through a Z-point representing an intersection between the X-axis and the Y-axis (the Z-point also representing the center point of the suspension of the car supporting frame 2). Under the effect of the driving forces generated by the combination of the magnetic actuators 72a and 72b or the combination of the magnetic actuators 72c and 72d, the elevator car 1 is rotationally driven relative to the car supporting frame 2 in or along the plane of FIGS. 3 so that the rotational vibration of the elevator car 1 can be reduced.

As can now be understood from the above description, with the vibration damping apparatus according to the second embodiment of the present invention, not only the vibration of the elevator car 1 in the X- and Y-directions but also the rotational vibration of the elevator car 1 around the Z-axis can be reduced by generating the forces along the two translation X- and Y-axes and in the direction around the Z-axis by driving the magnetic actuators 72a, . . . , 72d and 72A, . . . , 72D in appropriate combinations Thus, there has been provided the elevator system which can ensure comfortableness even in the superhigh-speed up/down operation of the elevator car.

Embodiment 3

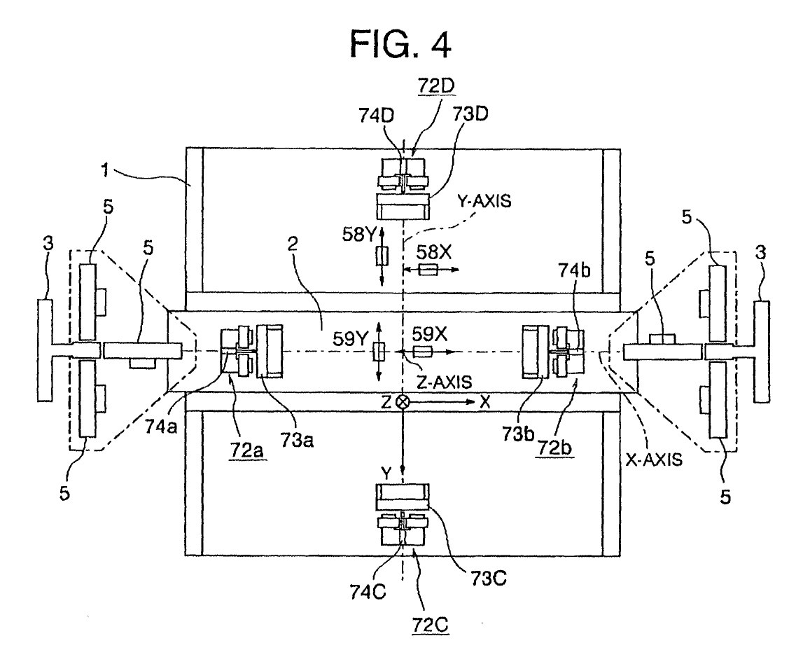

Next, the vibration damping apparatus for the elevator system according to a third embodiment of the present invention will be described by reference to FIG. 4 which is a bottom plan view of an elevator system equipped with the vibration damping apparatus according to the third embodiment of the invention. Incidentally, in FIG. 4, components or parts same as or equivalent to those mentioned hereinbefore in conjunction with the conventional system, the first embodiment or the second embodiment are denoted by like reference symbols and repeated description will be omitted.

According to the teachings of the present invention incarnated in the instant embodiment, four vibration damping units each composed of the magnetic actuators, the magnetic pole members and the displacement sensors arranged in the essentially same manner as the vibration damping apparatus described hereinbefore in conjunction with the first embodiment are disposed within the space defined between the floor of the elevator car 1 and the bottom member of the car supporting frame 2 along the X-axis and the Y-axis in a symmetrical arrangement, as shown in FIG. 4. More specifically, disposed on the X-axis are a pair of the magnetic actuators 72a and 72b, a pair of the magnetic pole members 73a and 73b and a pair of the displacement sensors 74a and 74b symmetrically to each other. Similarly, disposed on the Y-axis are a pair of the magnetic actuators 72C and 72D, a pair of the magnetic pole members 73C and 73D and a pair of the displacement sensors 74C and 74D symmetrically to each other.

With the arrangement described above, vibrations of the elevator car 1 in both the X-direction and the Y-direction can be reduced. In other words, the vibration components which make appearance in the X-direction of the elevator car 1 upon superhigh-speed up/down operation of the elevator car and which can not be reduced with the conventional vibration reducing mechanism such as the guide roller suspensions 5a and the rubber vibration isolators 7 and 8 can be suppressed with the arrangement according to the instant embodiment through the same process described hereinbefore in conjunction with the first embodiment of the invention. By way of example, when the elevator car 1 is to be moved in the (−)X-direction, the driving force is generated by the magnetic actuator 72a, whereas when the elevator car 1 is to be moved in the (+)X-direction, the driving force is generated by the magnetic actuator 72b. Owing to the driving force generated in this way, the elevator car 1 is moved to right or left relative to the car supporting frame 2, whereby the vibration of the elevator car 1 in the X-direction can be reduced.

Further, in case the vibration of the elevator car 1 occurs in the Y-direction, the elevator car 1 can be moved in the (+)Y-direction by generating the driving force by the magnetic actuator 72C or alternatively the elevator car 1 can be moved in the (−)Y-direction by generating the driving force by means of the magnetic actuator 72D. Owing to the driving forces generated in this way, the elevator car 1 can be moved frontward or backward (to the top or bottom as viewed in FIG. 4) relative to the car supporting frame 2, whereby the vibration of the elevator car 1 in the Y-direction can be attenuated.

As can now be understood from the above description, with the vibration damping apparatus according to the third embodiment of the present invention, the vibrations of the elevator car 1 in the X- and Y-directions can be reduced by generating the forces translationarily along the X- and Y-axes by driving selectively the magnetic actuators 72a; 72b and 72A; 72B in the manner described above. Thus, with the arrangement according to the third embodiment of the invention, space-, power- and cost-saving implementation of the vibration damping apparatus can be realized.

Embodiment 4

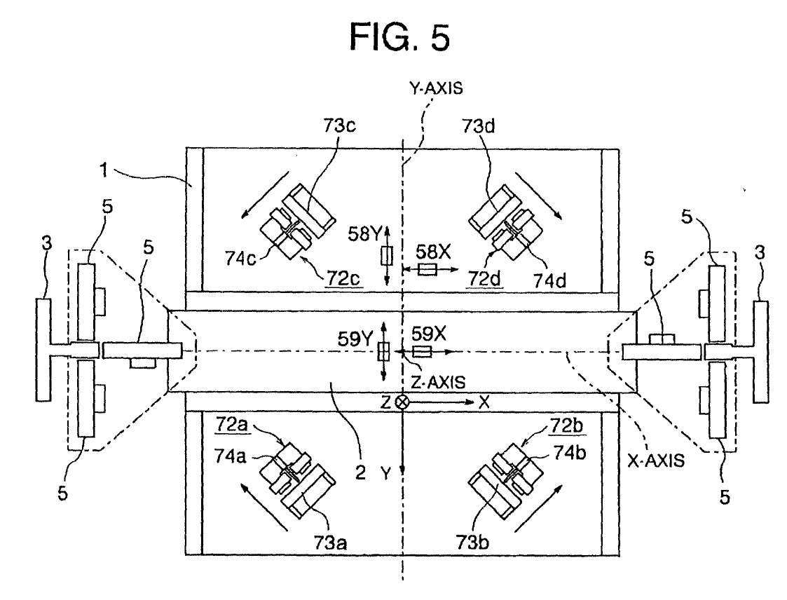

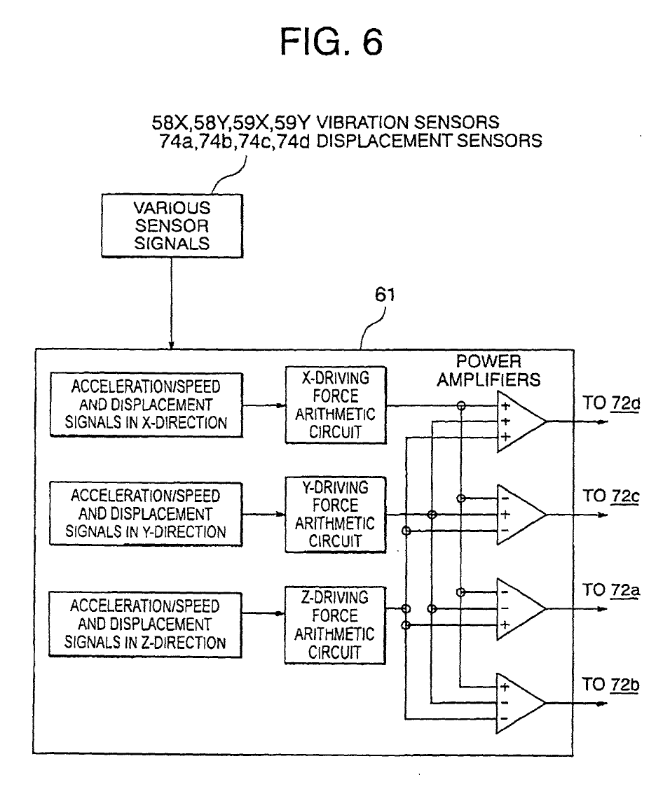

Next, the vibration damping apparatus according to a fourth embodiment of the present invention will be described by reference to FIGS. 5 and 6 in which FIG. 5 is a bottom plan view of an elevator equipped with the vibration damping apparatus according to the fourth embodiment of the invention, and FIG. 6 is a block diagram showing generally and schematically a controller of the vibration damping apparatus Incidentally, in FIGS. 5 and 6, components or parts same as or equivalent to those mentioned hereinbefore in conjunction with the conventional apparatus, the first embodiment or the second embodiment are denoted by like reference symbols and repeated description will be omitted.

According to the teachings of the present invention incarnated in the instant embodiment, four vibration damping units each composed of the magnetic actuator, the magnetic pole member and the displacement sensor arranged in the essentially same manner as the vibration damping apparatus described hereinbefore in conjunction with the first embodiment are disposed within the space defined between the floor of the elevator car 1 and the bottom member of the car supporting frame 2. More specifically, as can be seen in FIG. 5, the magnetic actuators 72a, 72b, 72c and 72d, the magnetic pole members 73a, 73b, 73c and 73d and the displacement sensors 74a, 74b, 74c and 74d are disposed at four locations, respectively, such that the vibration damping units each constituted by the magnetic actuator, the magnetic pole member and the displacement sensor assume respective positions symmetrically to the Z-point and that the directions of the driving forces generated by the vibration damping units form an angle of about 45 degrees relative to the X- and Y-axes, respectively.

By virtue of the arrangement of the vibration damping apparatus described, vibration components which may make appearance in the X-direction of the elevator car 1 and which can not be damped with the conventional vibration reducing mechanisms such as the guide roller suspensions 5a and the rubber vibration isolators 7 and 8 can be suppressed by generating the driving forces by means of the magnetic actuators 72a and 72c for thereby moving the elevator car 1 in the (−)X-direction or alternatively by generating the driving forces by means of the magnetic actuators 72b and 72d for thereby moving the elevator car 1 in the (+)X-direction. Owing to the driving forces generated in this way, the elevator car 1 can be moved to right or left relative to the car supporting frame 2, whereby vibration of the elevator car 1 can be reduced.

Further, the vibration components which may make appearance in the Y-direction of the elevator car 1 can be mitigated by generating the driving forces by means of the magnetic actuators 72c and 72d for thereby moving the elevator car 1 in the (+)Y-direction or alternatively by generating the driving forces by means of the magnetic actuators 72a and 72b for moving the elevator car 1 in the (−)Y-direction. Owing to the driving forces generated in this way, the elevator car 1 can be moved frontward or backward (to the top or bottom as viewed in FIG. 5) relative to the car supporting frame 2, whereby the vibration of the elevator car 1 can be reduced.

Furthermore, when the elevator car 1 is to be moved in the clockwise direction as viewed in the figure (i.e., plus-rotational direction) with reference to the Z-axis in order to cancel our the rotational vibration of the elevator car 1 around the Z-axis, the driving forces are generated through cooperation of the magnetic actuators 72a and 72d, whereas when the elevator car 1 is to be moved in the counterclockwise direction as viewed in the figure (i.e., minus-rotational direction) with reference to the Z-axis, the driving forces are generated through cooperation of the magnetic actuators 72b and 72c. As a result of this, the elevator car 1 is rotated relative to the car supporting frame 2 in the horizontal plane in the direction in which the rotational vibration of the elevator car 1 is reduced or suppressed.

FIG. 6 shows a block diagram for illustrating the vibration damping control operation described above. Referring to the figure, on the basis of the output signals of the vibration sensors 58X; 58Y and 59X; 59Y, the displacement sensors 74a; 74b and 74c; 74d, the signals representing the accelerations, the velocities and the displacements of the elevator car 1 in the X-direction and the Y-direction and around the Z-axis are generated. Subsequently, from the signals mentioned just above, the driving force components for driving the elevator car 1 in the X-direction, the Y-direction and around the Z-axis are arithmetically determined by means of an X-driving force arithmetic circuit, a Y-driving force arithmetic circuit and a Z-driving force arithmetic circuit, respectively, wherein when the polarities of the input signals to power amplifiers provided on the output sides of the arithmetic circuits mentioned above are such as illustrated in FIG. 6, the control command signal Tc is outputted to the magnetic actuators 72a, 72b, 72c and/or 72d from the relevant power amplifiers.

As can now be understood from the above description, with the vibration damping apparatus according to the fourth embodiment of the present invention, not only the vibration of the elevator car 1 in the X- and Y-directions but also the rotational vibration of the elevator car 1 around the Z-axis can be reduced by generating the force translationarily along the X- and Y-axes and in the rotational direction around the Z-axis by driving selectively the magnetic actuators 72a, . . . , 72d in appropriate combinations. Thus, the elevator according to the instant embodiment, vibrations of the elevator car in the X-direction and the Y-direction as well as the rotational vibration around the Z-axis can satisfactorily be reduced with the four magnetic actuators, whereby the vibration damping apparatus which enjoys the space-saving and inexpensive implementation can be realized.

Embodiment 5

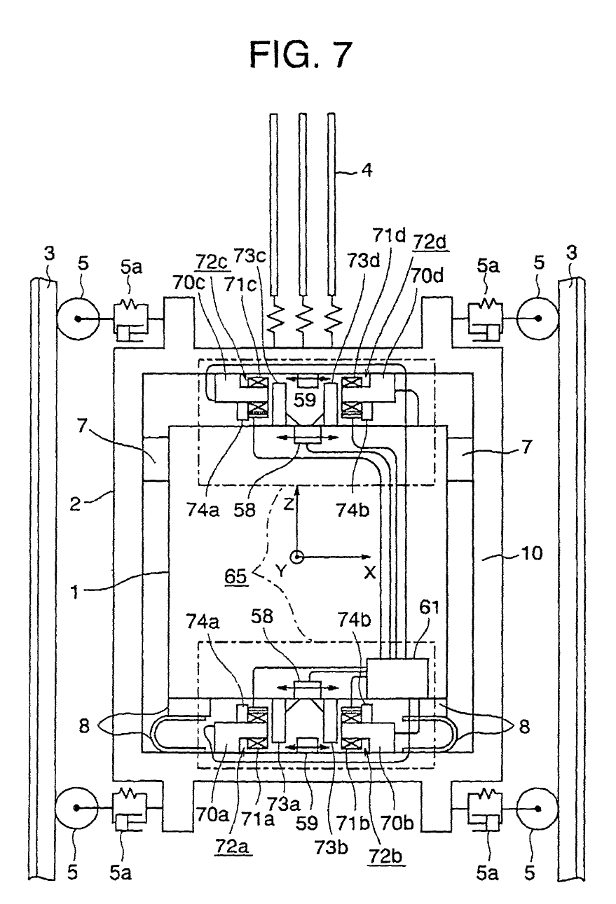

Next, the vibration damping apparatus for the elevator system according to a fifth embodiment of the present invention will be described by reference to FIG. 7 which is an elevational front-side view of the elevator system for illustrating the vibration damping apparatus according to the fifth embodiment of the invention. Incidentally, in FIG. 7, components or parts same as or equivalent to those mentioned hereinbefore in conjunction with the conventional apparatus and the first embodiment are denoted by like reference symbols and repeated description thereof is omitted.

According to the teachings of the present invention incarnated in the instant embodiment, a pair of vibration damping apparatuses 65 are disposed at the top and the bottom, respectively, of the elevator car 1. More specifically, one of the vibration damping apparatuses 65 is installed in the space defined between the floor of the elevator car 1 and the bottom member of the car supporting frame 2, while the other vibration damping apparatus 65 is installed within the space defined between the ceiling wall of the elevator car 1 and the top member of the car supporting frame 2. For the convenience of description, the former will be referred to as the lower vibration damping apparatus while the latter being referred to as the upper vibration damping apparatus. The lower vibration damping apparatus 65 is implemented in the utterly same structure as the vibration damping apparatus according to the first embodiment. The upper vibration damping apparatus 65 is realized in the same structure as the lower vibration damping apparatus 65 and disposed symmetrically relative to the latter. More specifically, the upper vibration damping apparatus 65 is composed of the magnetic actuators 72c and 72d including the iron cores 70c and 70d and the coils 71c and 71d, respectively, the magnetic pole members 73c and 73d, the displacement sensors 74c and 74d, the vibration sensor 58 installed on the ceiling wall of the elevator car 1, the vibration sensor 59 installed on the top member of the car supporting frame 2 and others The upper vibration damping apparatus 65 operates similarly to the lower vibration damping apparatus 65.

In the vibration damping apparatus according to the instant embodiment of the invention, the vibration of the elevator car 1 in the X-direction can be reduced while suppressing rotation of the elevator car around the Y-axis (i.e., vertical vibrationary movement of the elevator car 1) through the control process described hereinbefore in conjunction with the first embodiment of the invention. Thus, there is provided an elevator system which can ensure enhanced comfortableness in riding.

Embodiment 6

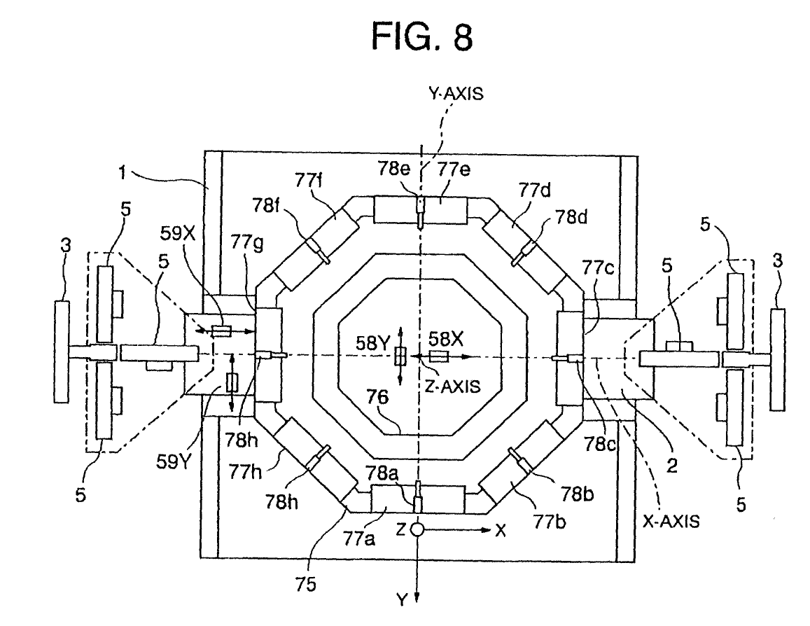

Next, the vibration damping apparatus according to a sixth embodiment of the present invention will be described by reference to FIG. 8 which is a bottom plan view of an elevator equipped with the vibration damping apparatus according to the sixth embodiment of the invention. Incidentally, in FIG. 8, components or parts same as or equivalent to those mentioned hereinbefore in conjunction with the conventional apparatus and the first embodiment are denoted by like reference symbols and repeated description will be omitted.

The vibration damping apparatus according to the instant embodiment of the invention features a simplified structure of the magnetic actuator disposed within the space defined between the floor of the elevator car 1 and the bottom member of the car supporting frame 2.

Referring to FIG. 8, reference numeral 75 denotes an iron core of an octagonal annular form and mounted on the bottom member of the car supporting frame 2, 76 denotes a magnetic pole member of an octagonal annular form in correspondence to the octagonal shape of the iron core 75 and mounted under the floor of the elevator car 1 at inner side of the iron core 75 substantially in parallel with the latter, and reference symbols 77a to 77h denote coils wound around straight sections of the octagonal annular iron core 75. Further, reference symbols 78a to 78h denote displacement sensors for measuring the displacement or gap distance between the appropriately disposed straight sections of the iron core 75 and the magnetic pole member 76, respectively. In the case of the vibration damping apparatus now under consideration, the magnetic actuator is implemented in a unitary structure including the iron core 75 and the coils 77a to 77h.

In the vibration damping apparatus of the structure described above, when the driving force for pulling the elevator car 1 toward the car supporting frame 2 in the (+)X-direction is to be generated in order to suppress the vibration of the elevator car 1 in the X-direction which may occur in the course of superhigh-speed up/down operation of the elevator car 1, a driving current is caused to flow through the coil 77c wound around the section of the iron core 75 which is located at the plus-side position on the X-axis to thereby allow the coil 77c to magnetically attract the oppositely disposed magnetic pole member 76. Further, when the driving force for pulling the elevator car 1 toward the car supporting frame 2 in the (−)X-direction is to be generated, a driving current is caused to flow through the coil 77g wound around the section of the iron core 75 which is located at the minus-side position on the X-axis to thereby allow the coil 77g to magnetically attract the oppositely disposed magnetic pole member 76.

On the other hand, when the driving force for moving the elevator car 1 toward the car supporting frame 2 in the (+)Y-direction is to be generated in order to suppress the vibration of the elevator car 1 in the Y-direction, a driving current is caused to flow through the coil 77a wound around the section of the iron core 75 which is located at the plus-side position on the Y-axis to thereby allow the coil 77a to magnetically attract the oppositely disposed magnetic pole member 76. Further, when the driving force for pulling the elevator car 1 toward the car supporting frame 2 in the (−)Y-direction is to be generated, a driving current is allowed to flow Through the coil 77e wound around the section of the iron core 75 which is located at the minus-side position on the Y-axis to thereby make the coil 77e magnetically attract the oppositely disposed magnetic pole member 76.

Furthermore, when a driving force for magnetically pulling the elevator car 1 relative to the car supporting frame 2 in the direction which forms 45 degrees To the X-direction or the Y-direction, the driving current is then supplied to the coil 77b, 77d, 77f or 77h.

As is apparent from the above, in the vibration damping apparatus according to the sixth embodiment of the invention, the magnetic actuator implemented in the unitary structure including the annular iron core 75 and the coils 77a to 77h can be so operated as to generate the driving forces translationally in the X- and Y-directions, whereby suppression of the vibrations of the elevator car 1 in the X- and Y-directions can be accomplished Thus, vibration damping apparatus features the simplified structure, facilitated mounting, low-cost and easy maintenance, to advantages.

Embodiment 7

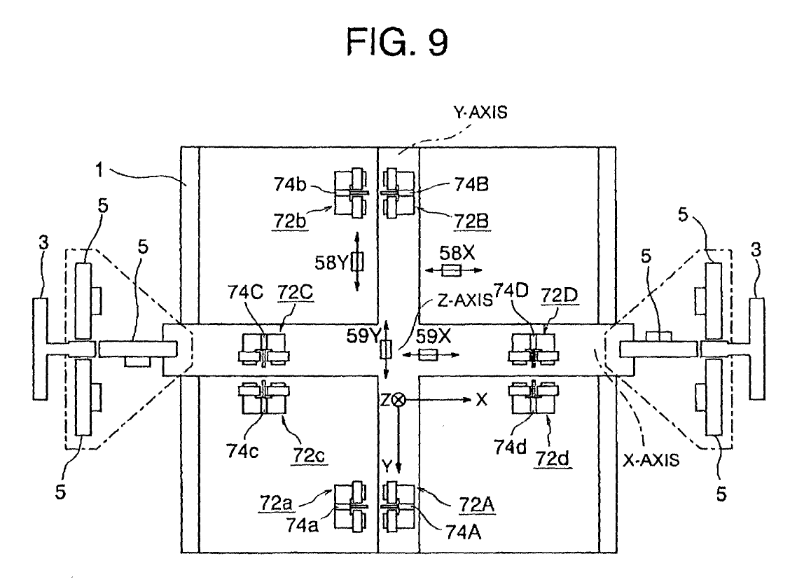

Next, the vibration damping apparatus for the elevator system according to a seventh embodiment of the present invention will be described by reference to FIG. 9 which is a bottom plan view of an elevator equipped with the vibration damping apparatus according to the instant embodiment of the invention. Incidentally, in FIG. 9, components or parts same as or equivalent to those mentioned hereinbefore in conjunction with the conventional apparatus, the first embodiment or the second embodiment are denoted by like reference symbols and repeated description will be omitted.

According to the teachings of the present invention incarnated in the seventh embodiment, the magnetic actuators 72a, 72b, 72c, 72d and 72A, 72B, 72C, 72D and the displacement sensors 74a, 74b, 74c, 74d and 74A, 74B, 74C, 74D each implemented in the essentially same structure as those described hereinbefore in conjunction with the first embodiment are disposed within the space defined between the floor of the elevator car 1 and the bottom member of the car supporting frame 2 at four locations substantially on and along the X- and Y-axes in the form of four sets each including a pair of the magnetic actuators and a pair of displacement sensors 74a, as is shown in FIG. 9. In each of these sets, the paired magnetic actuators 72a and 72A, 72b and 72B, 72c and 72C and 72d and 72D face in opposition to each other in the direction orthogonal to the adjacent axis X or Y.

By way of example, on the plus-side of the Y-axis, the magnetic actuators 72a and 72A are so disposed that the tip end portions of the coil-wound cross of these magnetic actuators are oriented oppositely to each other in the direction corresponding to the X-axis.

At this juncture, it should also be added that the magnetic actuators 72a, 72b, 72c and 72d are mounted on the bottom member of the car supporting frame 2 while the magnetic actuators 72A, 72B, 72C and 72D are mounted under the floor of the elevator car 1 (i.e., actuators 72A, 72B, 72C and 72D are secured to the car 1). Further, the paired magnetic actuators, i.e., 72a and 72A, 72b and 72B, 72c and 72C; 72d and 72D, are adapted to generate the magnetic attracting force and magnetic repulsive force in dependence on the combination of the directions of the driving currents applied to these paired magnetic actuators.

Thus,in the vibration damping apparatus according to the instant embodiment of the invention, when the driving force is to be generated such that the elevator car 1 is moved in the (−)X-direction, the directions of driving currents fed to the coils of the paired magnetic actuators 72a; 72A and 72b; 72B are so selected that the magnetic attracting forces are generated by these paired magnetic actuators. On the other hand, when the driving force is to be generated such that the elevator car 1 is moved in the (+)X-direction, the directions of driving currents fed to the coils of the paired magnetic actuators 72a; 72A and 72b; 72B are so selected that the repulsive forces are generated by these paired magnetic actuators. In this manner, the elevator car 1 can be moved to left and right relative to the car supporting frame 2, whereby the vibration of the elevator car 1 in the X-direction can be reduced.

Similarly, when the vibration of the elevator car 1 in the Y-direction is to be reduced, the directions of driving currents fed to the coils of the paired magnetic actuators 72c; 72C and 72d; 72D are so selected that the magnetic attracting forces or repulsive forces are generated by these paired magnetic actuators. In this manner, the elevator car 1 can be moved frontward and backward (upward/downward as viewed in FIG. 9) relative to the car supporting frame 2, whereby the vibration of the elevator car 1 in the Y-direction can be reduced.

Furthermore, when the elevator car 1 is to be moved in the clockwise direction as viewed in FIG. 9 (i.e., plus-rotational direction) with reference to the Z-axis, the magnetic attracting forces are generated by the magnetic actuators 72a and 72d with the magnetic repulsive force being generated between the magnetic actuators 72b and 72B. On the other hand, when the elevator car 1 Is to be moved in the counterclockwise direction as viewed in FIG. 9 (i.e., minus-rotational direction) around the Z-axis, the magnetic repulsive forces are generated between the magnetic actuators 72a and 72A with the magnetic attracting forces being generated by the magnetic actuators 72b and 72B.

As can now be understood from the above description, with the vibration damping apparatus according to the seventh embodiment of the present invention, not only the vibration of the elevator car 1 in the X- and Y-directions but also the rotational vibration of the elevator car 1 around the Z-axis can be reduced or suppressed by generating the force translationarily along the X- and Y-axes and in the direction around the Z-axis by selectively driving the magnetic actuators 72a, . . . , 72d and 72A, . . . , 72D in appropriate combinations.

Embodiment 8

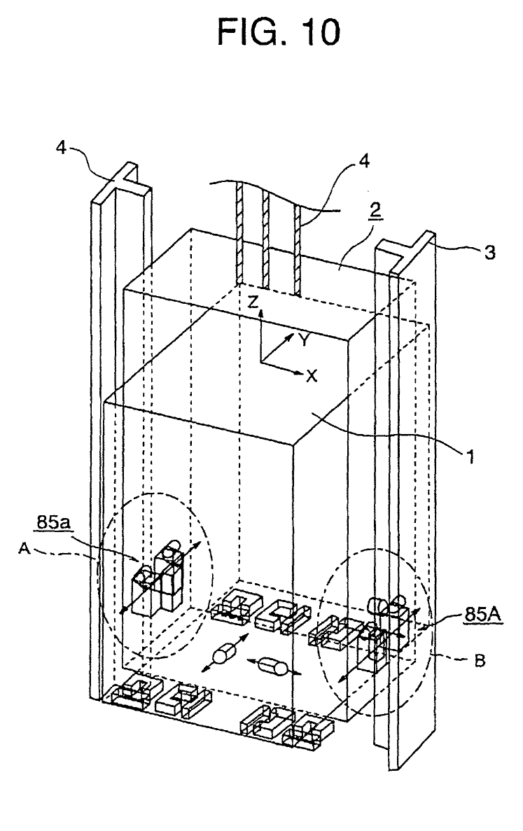

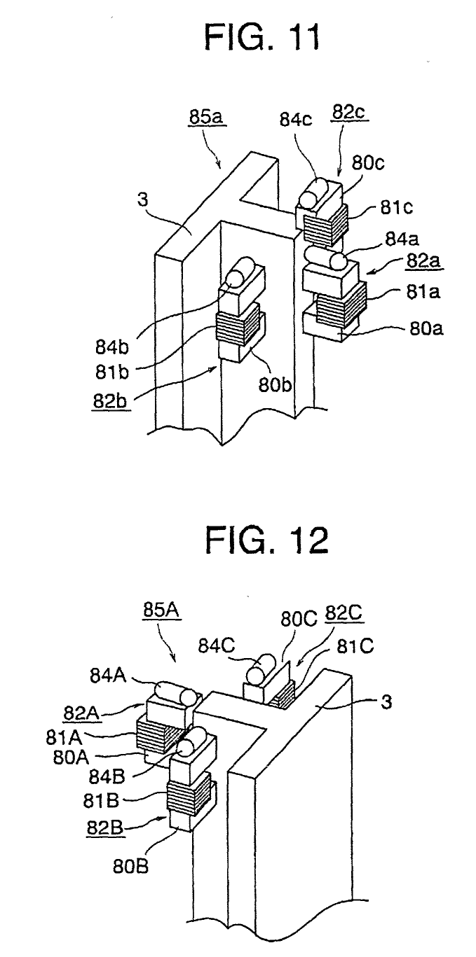

Next, the vibration damping apparatus for the elevator system according to an eighth embodiment of the present invention will be described by reference to FIGS. 10 to 12, wherein FIG. 10 is a perspective view of an elevator system equipped with the vibration damping apparatus according to the instant embodiment of the invention, FIG. 11 is an enlarged fragmental view of a portion (left-hand magnetic guide unit) indicated as enclosed by a broken line circle A in FIG. 10, and FIG. 12 is an enlarged fragmental view of a portion (right-hand magnetic guide unit) indicated as enclosed by a broken line circle B in FIG. 10. Incidentally, in these figures, components or parts same as or equivalent to those mentioned hereinbefore in conjunction with the conventional apparatus and the first embodiment of the invention are denoted by like reference symbols and repeated description will be omitted.

In the vibration damping apparatus according to the eighth embodiment of the invention, the guide rollers (rail follower) 5 is replaced by a magnetic guide unit for the purpose of suppressing relative movements between the guide rail 3 and the car supporting frame 2 to thereby reduce the vibration of the elevator car 1 in the horizontal direction.

Referring to FIGS. 10 to 12, reference symbols 80a, 80b and 80c; 80A, 80B and 80C denote iron cores, respectively, which are mounted on the car supporting frame 2, symbols 81a, 81b, 81c; 81A, 81B, 81C denote coils wound around the iron cores 80a to 80c and 80A to 80C, respectively, and reference characters 82a, 82b, 82c; 82A, 82B, 82C denote magnetic actuators constituted by the iron cores 80a, 80b, 80c; 80A, 80B, 80C and the iron cores 81a, 81b, 81c; 81A, 81B, 81C, respectively. The magnetic actuators 82a to 82c are so designed as to face oppositely to the exposed faces of a rectangular projection of the left-hand guide rail 3 implemented so as to have a T-like cross-section, as can be seen in FIG. 11, while the magnetic actuators 82A to 82C are so designed as to face oppositely to the exposed faces of a rectangular projection of the right-hand guide rail 3 which is so implemented as to have a T-like cross-section, as shown in FIG. 11. Further, reference characters 84a to 84c and 84A to 84C denote displacement sensors, respectively, which is designed to measure the positional deviations or displacements between the left-hand guide rail 3 and the magnetic actuators 82a, 82b and 82c as well as the displacements between the right-hand guide rail 3 and the magnetic actuators 82A, 82B and 82C, respectively. Thus, the left-hand magnetic guide unit 85a is constituted by the magnetic actuators 82a, 82b and 82c, the displacement sensors 84a, 84b and 84c and the left-hand guide rail 3 Similarly, the right-hand magnetic guide unit 85A is constituted by the magnetic actuators 82A, 82B and 82C, the displacement sensors 84A, 84B and 84C and the right-hand guide rail 3. Incidentally, it is presumed that the vibration damping apparatus described hereinbefore in conjunction with the second embodiment of the invention (see FIG. 3) is installed in the space defined between the floor of the elevator car 1 and the bottom member of the car supporting frame 2.

Next, description will be directed to a method of supporting The car supporting frame 2 of The elevator in the X-direction. As mentioned hereinbefore, the top member of the car supporting frame 2 is suspended by a plurality of the main ropes 4 (three main ropes in the illustrated system). Driving currents are fed to the magnetic actuators 82a and 82A, respectively, to thereby generate in advance magnetic attracting forces between the left-hand and right-hand guide rails and the above-mentioned magnetic actuators, respectively, at the bottom member of the car supporting frame 2 so that the car supporting frame 2 can be suppressed at a neutral position in a contactless state.

In the superhigh-speed up/down operation of the elevator car, when the magnetic actuator 82a approaches to the left-hand guide rail 3 due to the joint or curvature of the left-hand guide rail 3, this approach is detected by the displacement sensor 84a, and then the driving current fed to the magnetic actuator 82a is decreased while the driving current fed to the magnetic actuator 82A is increased. As a result of this, the car supporting frame 2 is caused to move rightward, as viewed in FIG. 10. In this manner, the car supporting frame 2 and the guide rail 3 are held in the contactless state during the superhigh-speed up/down operation of the elevator car. On the other hand, when the magnetic actuator 82A approaches to the right-hand guide rail 3, this approach is detected by the displacement sensor 84A, and then the driving current fed to the magnetic actuator 82A is decreased while the driving current fed to the magnetic actuator 82a is increased. As a result of this, the car supporting frame 2 is caused to move leftward, as viewed in FIG. 10. In this manner, the car supporting frame 2 and the guide rail 3 are held in the contactless state during the superhigh-speed up/down operation of the elevator car.

Similarly, supporting of the elevator car in the Y-direction can be realized through cooperation of the pair of magnetic actuators 82b and 82c along the left-hand guide rail, while for the right-hand guide rail, the pair of magnetic actuators 82B and 82C are put into operation. In this manner, the elevator car can be held or supported in the contactless state during the superhigh-speed up/down operation.

Further, for the supporting of the elevator car around the Z-axis, the car supporting frame 2 can be held in the contactless state relative to the guide rails 3 through cooperation of the paired magnetic actuators 82b and 82C and the paired magnetic actuators 82B and 82c.

By virtue of the arrangement of the vibration damping apparatus described above, the car supporting frame 2 can be held in the contactless state by means of the magnetic guide units 85a and 85A on the left and right sides at the lower portion of the car supporting frame 2 during the superhigh-speed up/down operation of the elevator car, and thus the car supporting frame 2 can be protected against vibrations which may be brought about by joints and/or curvatures of the guide rails 3. Even in the case where the joints and/or curvatures of the guide rails 3 are remarkable and where vibrations are transmitted to the car supporting frame 2 by way of the main ropes 4, the vibration of the elevator car 1 can be suppressed by means of the vibration damping apparatus disposed between the elevator car 1 and the car supporting frame 2 (see FIG. 3) through the control process described hereinbefore in conjunction with the second embodiment of the invention.

As can now be appreciated from the above, the vibration damping apparatus according to the eighth embodiment of the invention can ensure further enhanced comfortableness in the superhigh-speed up/down operation of the elevator car.

Embodiment 9

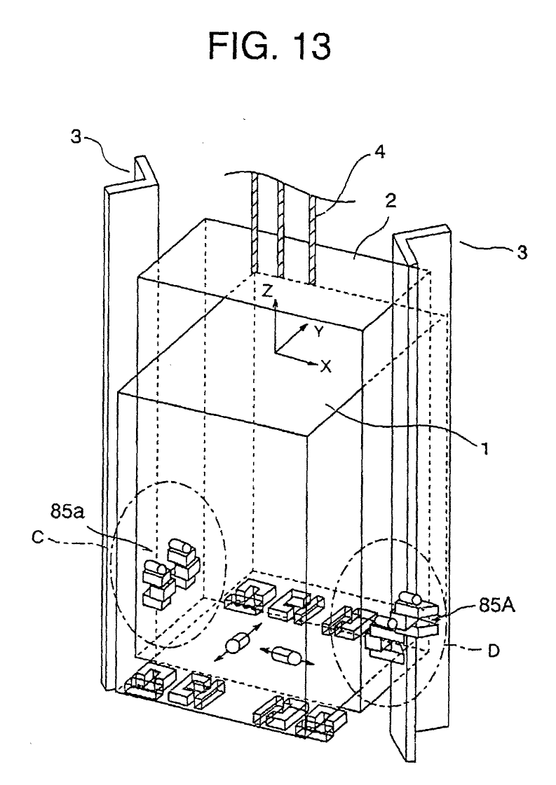

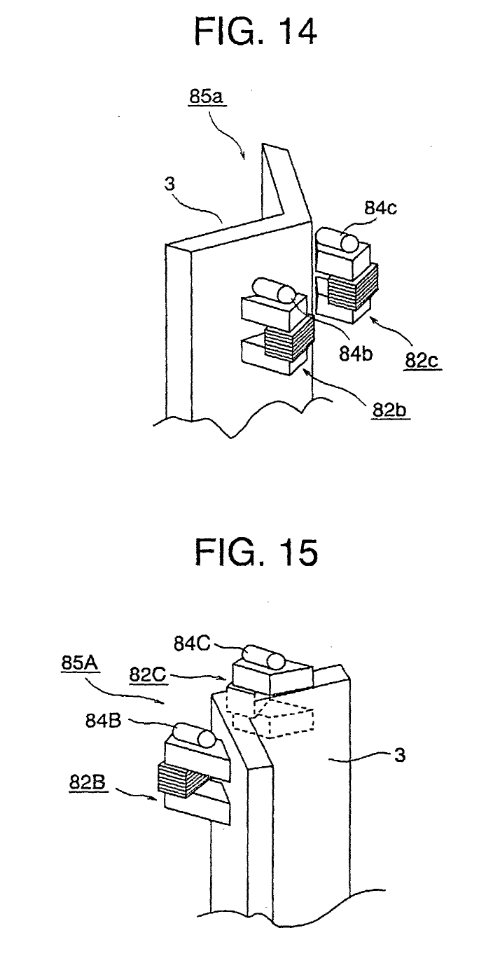

Next, the vibration damping apparatus for the elevator system according to a ninth embodiment of the present invention will be described by reference to FIGS. 13 to 15, wherein FIG. 13 is a perspective view of an elevator system according to the instant embodiment of the invention, FIG. 14 is an enlarged fragmental perspective view of a portion indicated as enclosed by a broken line circle C in FIG. 13, and FIG. 15 is an enlarged fragmental perspective view of a portion indicated as enclosed by a broken line circle D in FIG. 13. Incidentally, in these figures, components or parts same as or equivalent to those mentioned hereinbefore in conjunction with the conventional apparatus or the first and eighth embodiments are denoted by like reference symbols and repeated description will be omitted.

In the vibration damping apparatus according to the ninth embodiment of the invention, the guide rail 3 are each implemented in the form of an angle member having a V-like cross section and the guide rollers (rail follower) 5 are each replaced by a magnetic guide unit for suppressing vlbrationarily relative movements which may occur between the guide rail 3 and the car supporting frame 2 to thereby mitigate the vibration of the elevator car 1.

Referring to FIGS. 13 to 15, the left-hand guide rail 3 formed of an angle member having a V-like cross section presents two lateral faces in opposition to which magnetic actuators 82b and 82c and displacement sensors 84b and 84c are disposed, respectively, being secured fixedly to the car supporting frame 2. The magnetic actuators 82b; 82c and the displacement sensors 84b; 84c cooperate to constitute a left-hand magnetic guide unit 85a. Similarly, the right-hand guide rail 3 formed of an angle member having a V-like cross section presents two lateral faces in opposition to which magnetic actuators 82B and 82C and displacement sensors 84B and 84C are disposed, respectively, being secured fixedly to the car supporting frame 2. The magnetic actuators 82B; 82C and the displacement sensors 84B; 84C cooperate to constitute a right-hand magnetic guide unit 85A. Incidentally, it is presumed that the vibration damping apparatus described hereinbefore in conjunction with the second embodiment of the invention (see FIG. 3) is installed in the space defined between the floor of the elevator car 1 and the bottom member of the car supporting frame 2, as can be seen in FIG. 13.

Next, description will be directed to a method of supporting the car supporting frame 2 of the elevator in the X-direction. As mentioned hereinbefore, the top member of the car supporting frame 2 is suspended by a plurality of the main ropes 4 (three main ropes in the case of the instant embodiment). Driving currents are fed to the magnetic actuators 82b, 82c, 82B and 82C, respectively, to thereby generate in advance magnetic attracting forces between the left-hand and right-hand guide rails 3 and the above-mentioned magnetic actuators, respectively, at or in the vicinity of the bottom member of the car supporting frame 2 so that the car supporting frame 2 can be suppressed at a neutral position in a contactless state.

In the superhigh-speed up/down operation of the elevator car, when the magnetic actuators 82b and 82c approach to the left-hand guide rail 3 due to the joint or curvature of the left-hand guide rail 3, this approach is detected by the displacement sensors 84b and 84c, and then the driving current fed to the magnetic actuators 82b and 82c is decreased while the driving current fed to the magnetic actuators 82B and 82C is increased. As a result of this, the car supporting frame 2 is caused to move rightward. In this manner, the car supporting frame 2 and the guide rail 3 are held in the contactless state during the superhigh-speed up/down operation of the elevator car. On the other hand, when the magnetic actuators 82B and 82C approach to the right-hand guide rail 3, this approach is detected by the displacement sensors 84B and 84C, and then the driving current fed to the magnetic actuators 82B and 82C is decreased while the driving current fed to the magnetic actuators 82b and 82c is increased. As a result of this, the car supporting frame 2 is caused to move leftward. In this manner, the car supporting frame 2 and the guide rail 3 are held in the contactless state during the superhigh-speed up/down operation of the elevator car.

Supporting of the car supporting frame 2 in the Y-direction can also be effected in the similar manner as in the X-direction. More specifically, when the magnetic actuators 82b and 82B approach to the left-hand guide rail 3 due to the joint or curvature of the left-hand guide rail 3 in the course of superhigh-speed up/down operation of the elevator car, this approach is detected by the displacement sensors 84b and 84B, and then the driving current fed to the magnetic actuators 82b and 82B is decreased while the driving current fed to the magnetic actuators 82c and 82C is increased. As a result of this, the car supporting frame 2 is moved in the (+)Y-direction. In this manner, the car supporting frame 2 and the left-hand guide rail 3 are held in the contactless state during the superhigh-speed up/down operation. On the other hand, when the magnetic actuators 82c and 82C approach to the right-hand guide rail 3, this approach is detected by the displacement sensors 84c and 84C, and then the driving current fed to the magnetic actuators 82c and 82C is decreased while the driving current fed to the magnetic actuators 82b and 82B is increased. Thus, the car supporting frame 2 is caused to move in the (−)Y-direction. In this manner, the car supporting frame 2 and the guide rail 3 are held in the contactless state during the superhigh-speed up/down operation of the elevator car.

Further, through a similar control for supporting the elevator car around the Z-axis, the car supporting frame 2 can be held in the contactless state relative to the guide rails 3 through cooperation of the pair of magnetic actuators 82b and 82C and the pair of magnetic actuators 82B and 82c.

By virtue of the arrangement of the vibration damping apparatus described above, the car supporting frame 2 can be held in the contactless state by means of the magnetic guide units 85a and 85A on the left and right sides at the lower portion of the elevator car during the superhigh-speed up/down operation of the elevator car, and thus the car supporting frame 2 can be protected against vibrations which may be brought about by joints and/or curvatures of the guide rails 3. Even in the case where the joints and/or curvatures of the guide rails 3 are remarkable and where the vibrations are transmitted to the car supporting frame 2 by way of the main ropes 4, the elevator car 1 can be protected against the vibration by means of the vibration damping apparatus installed between the elevator car 1 and the car supporting frame 2 (see FIG. 3) through the control process described hereinbefore in conjunction with the second embodiment of the invention.

The vibration damping apparatus according to the ninth embodiment of the invention described above can be implemented at low cost while ensuring high performance by virtue of the fact that the guide rail 3 is formed of a simple angle member having V-like cross section and that each of the left- and right-hand magnetic guide units 85a and 85A can be realized with a pair of magnetic actuators.

Embodiment 10

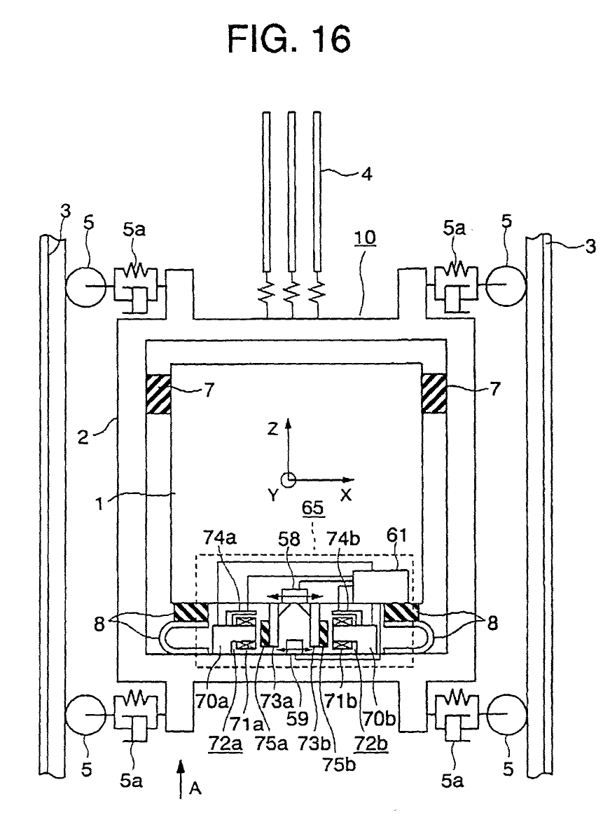

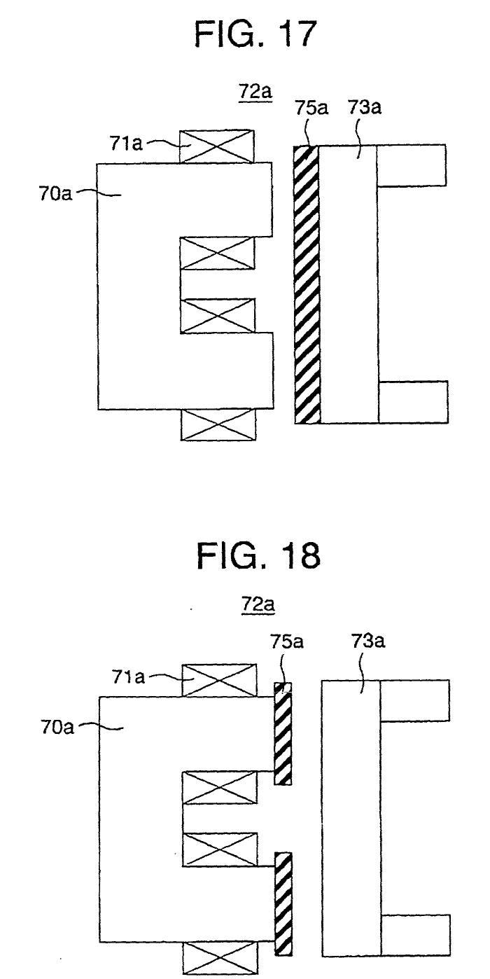

FIG. 16 is an elevational front-side view showing an vibration damping apparatus for an elevator according to a tenth embodiment of the present invention, and FIG. 17 is a bottom plan view of a magnetic attraction type actuator provided at one side, as viewed in the direction indicated by an arrow A in FIG. 16.

Referring to FIG. 16, reference numerals 75a and 75b denote shock absorbing or cushioning pads, respectively, which are secured on the surfaces of magnetic pole members 73a and 73b which face in opposition to iron cores 70a and 70b of the actuator 72a and 72b, respectively. The cushioning pads 75a and 75b may be made of rubber, cushion, plastic or the like material.

FIG. 17 is an enlarged view showing constituent parts of the magnetic attraction type actuator 72a. As can clearly be seen in FIG. 17, the cushioning pad 75a is fixedly secured onto the end face of the magnetic pole member 73a which faces in opposition to the magnetic attraction type actuator 72a.

Turning back to FIG. 16, reference numeral 58 denotes a vibration sensor installed on the floor of the elevator car 1, 59 denotes a vibration sensor installed on the bottom member of the car supporting frame 2, and reference numeral 61 denotes a controller to which the signals derived from the outputs of the vibration sensors 58 and 59 are inputted and which is designed or programmed to issue a control command(s) to the magnetic attraction type actuator 72a; 72b, as in the case of the conventional vibration damping apparatus described above. At this juncture, it should be added that the magnetic attraction type actuator 72a, the magnetic pole member 73a, the displacement sensor 74a and the cushioning pad 75a on one hand and the magnetic attraction type actuator 72b, the magnetic pole member 73b, the displacement sensor 74b and the cushioning pad 75b on the other hand are implemented in mutually same structures, respectively, and mounted symmetrically to each other.

Next, description will be made of operation of the vibration damping apparatus. In the course of up/down operation of the elevator car, vibration components of the elevator car 1 which can not be suppressed by means of the vibration damping mechanism such as the guide roller suspensions 5a, the rubber vibration isolators 7 and 8 and other may occur in the horizontal direction of the elevator car 1 under the influence of joints and/or curvatures of the guide rail 3. Vibration of the floor of the elevator car 1 is detected by the vibration sensor 58, while the vibration of the car supporting frame 2 is then detected by the vibration sensor 59. Relative displacement between the elevator car 1 and the car supporting frame 2 is detected by the displacement sensors 74a and 74b. The output signals of these sensors are supplied to the controller 61 which responds thereto by generating the control command signal for the magnetic attraction type actuators 72a and 72b, which are then so driven in response to the control command signal that the vibration level of the floor of the elevator car 1 is reduced. By feeding the driving current to the coil 71a; 71b wound around the iron core 70a; 70b, magnetic attracting force is generated for the magnetic pole member 73a; 73b. Since the magnetic pole members 73a and 73b are mounted under the floor of the elevator car 1, the elevator car 1 is caused to move leftward or rightward relative to the car supporting frame 2, as viewed in the figure. Thus, the vibration level mentioned above can be reduced.

As described hereinbefore in conjunction with the object of the present invention, the iron core 70a and the magnetic pole member 73a or the iron core 70b and the magnetic pole member 73b tend to move close to each other when positional deviations of the constituent parts of the apparatus take place from the initial positions due to malfunction of the controller 61 or aged deterioration of the parts. In this conjunction, it is to be noted that in the vibration damping apparatus according to the instant embodiment of the invention, the cushioning pad 75a is interposed between the iron core 70a and the magnetic pole member 73a while the cushioning pad 75b is interposed between the iron core 70b and the magnetic pole member 73b. Accordingly, the shocks can be absorbed by these cushioning pads 75a and 75b. In this manner, occurrence of shock due to collision between the elevator car 1 and the car supporting frame 2 can satisfactorily be prevented. In this manner, the up/down operation of the elevator car can be carried out with high safety without imparting uncomfortableness to the passengers.

Furthermore, in the vibration damping apparatus according to the instant embodiment of the invention, the magnetic attraction type actuator 72a; 72b can be protected against distortion or deformation due to the impact force. Besides, the problem of the installation rigidity becoming feeble can successfully be coped with.

As is apparent from the above, the cushioning pads 75a and 75b are disposed for absorbing the impact force acting between the elevator car 1 and the car supporting frame 2. By virtue of this feature, safety can be ensured even in the unexpected situation such as stoppage of the elevator car upon occurrence of interruption of service or the like event. In other words, sufficient fail-safe function is provided by the cushioning pads.

Embodiment 11

FIG. 18 is a bottom plan view of a vibration damping apparatus for the elevator system according to an eleventh embodiment of The present invention.

Referring to FIG. 18, in the vibration damping apparatus according to the instant embodiment of the invention, the cushioning pad 75a is mounted on the magnetic attraction type actuator 72a. More specifically, the cushioning pad 75a is mounted on the end faces of the coil-wound core 70a of the magnetic attraction type actuator 72a which face in opposition to the magnetic pole member 73a. The vibration damping control system according to the instant embodiment is capable of mitigating the impact force by preventing direct collision between the iron core 70a and the magnetic pole member 73a, as in the case of the tenth embodiment of the invention.

Embodiment 12

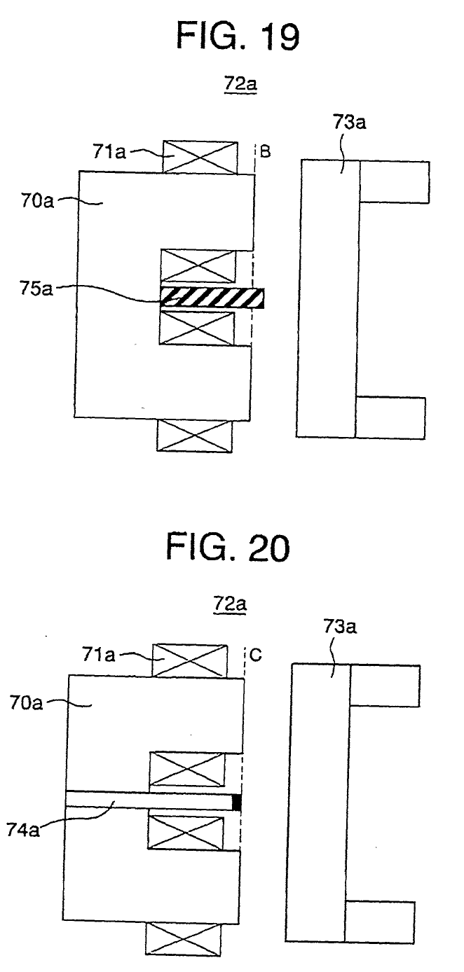

FIG. 19 is a bottom plan view of a vibration damping apparatus for the elevator system according to a twelfth embodiment of the present invention.

Referring to FIG. 19, in the vibration damping apparatus now under consideration, the cushioning pad 75a is mounted at a center portion of the magnetic attraction type actuator 72a which is implemented substantially in a C-like structure. Further, the tip end portion of the cushioning pad 75a projects beyond the attracting end face B of the iron core 70a of the magnetic attraction type actuator 72a by several millimeters. Owing to the arrangement mentioned above, direct collision between the iron core 70a and the magnetic pole member 73a can be prevented without fail with the impact force being mitigated by absorption.

Embodiment 13

FIG. 20 is a bottom plan view of a vibration damping apparatus for the elevator system according to a thirteenth embodiment of the present invention.

Referring to FIG. 20, in the vibration damping apparatus now under consideration, the displacement sensor 74a is disposed at a center portion of the magnetic attraction type actuator 72a of a substantially C-like structure. It is however to be noted that the detection face of the displacement sensor 74a is so positioned as to coincide with the attracting end face C of the coil-wound core 70a of the magnetic attraction type actuator 72a. By disposing the displacement sensor 74a in this manner, the value represented by the detection signal outputted from the displacement sensor 74a coincides with the actual gap value with high accuracy, which thus allows the vibration control to be carried out with much improved performance.

Furthermore, the vibration damping apparatus according to the instant embodiment of the invention can easily be assembled with high precision because what is important is only to dispose the magnetic attraction type actuator 72a and the displacement sensor 74a such that the tip end face of the displacement sensor 74a is positioned on the same plane as the attracting end face of the magnetic attraction type actuator 72a. Thus, the vibration damping apparatus can be manufactured at low cost while ensuring high performance

Embodiment 14

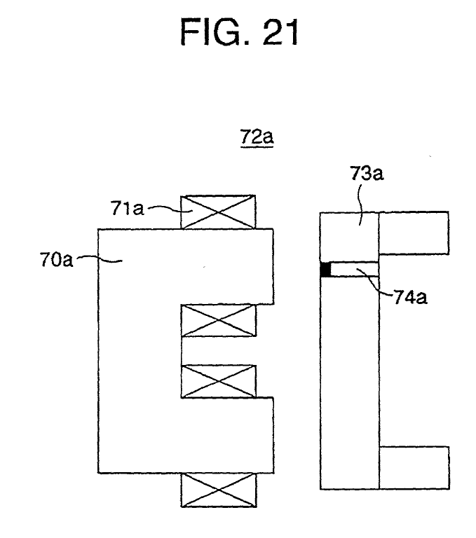

FIG. 21 is a bottom plan view of a vibration damping apparatus for the elevator system according to a fourteenth embodiment of the present invention.

Referring to FIG. 21, in the vibration damping apparatus now concerned, the displacement sensor 74a is mounted, being embedded in the magnetic pole member 73a so that the displacement sensor 74a can measure the displacement of the magnetic pole face of the iron core 70a of the magnetic attraction type actuator 72a. Further, the displacement sensor 74a is so disposed that the reference face of the displacement sensor 74a is flush with the surface of the magnetic pole member 73a disposed in opposition to the magnetic attraction type actuator. By disposing the displacement sensor 74a in this manner, the value detected by the displacement sensor 74a coincides with the actual gap value with high accuracy, which thus allows the vibration control to be performed with enhanced performance.

The vibration damping apparatus according to the instant embodiment of the invention can easily be assembled with high precision because what is required is to dispose the magnetic attraction type actuator 72a and the displacement sensor 74a such that the tip end face of the displacement sensor 74a is positioned on the same plane as the end face of the magnetic pole member 73a. Thus, the vibration damping apparatus can be manufactured at low cost while ensuring enhanced performance.

Embodiment 15

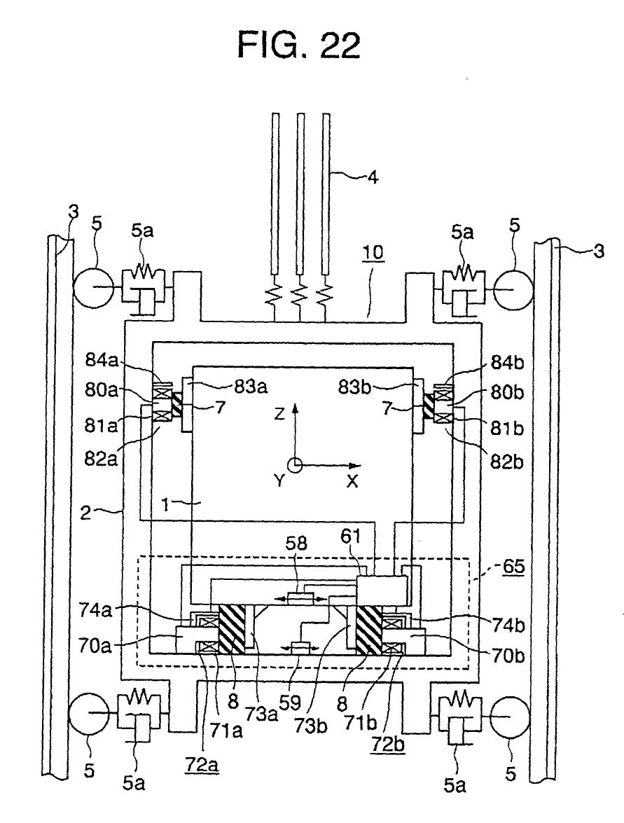

FIG. 22 is an elevational front-side view showing a structure of a vibration damping apparatus according to a fifteenth embodiment of the present invention.

Referring to FIG. 22, reference numerals 70a and 70b denote iron cores, respectively, which are mounted on the car supporting frame 2, numerals 71a and 71b denote coils wound around the iron cores 70a and 70b, respectively, numeral 72a denotes a magnetic attraction type actuator including the iron core 70a and the coil 71a, numeral 72b denotes a magnetic attraction type actuator including the iron core 70b and the coil 71b, numeral 73a and 73b denote magnetic pole members each formed of a magnetic material to be magnetically attracted and mounted under the floor of the elevator car so as to face in opposition to the magnetic attraction type actuators 72a and 72b, respectively, and reference numeral 74a and 74b denote displacement sensors for measuring displacements or gap distances between the tip end of the iron core 70a and the magnetic pole member 73a and between the tip end of the iron core 70b and the magnetic pole member 73b, respectively.

In the vibration damping apparatus now concerned, the magnetic actuators 72a; 72b and the magnetic pole members 73a; 73b are so disposed that the rubber vibration isolators 8 conventionally mounted on the bottom member of the elevator car 1 at left and right sides, respectively, are sandwiched between the magnetic attraction type actuator 72a and the magnetic pole member 73a and between the magnetic attraction type actuator 72b and the magnetic pole member 73b, respectively.

Further, reference numerals 80a and 80b denote iron cores, respectively, which are mounted on the car supporting frame 2, numerals 81a and 81b denote coils wound around the iron cores 80a and 80b, respectively, numeral 82a denotes a magnetic attraction type actuator including the iron core 80a and the coil 81a, numeral 82b denotes a magnetic attraction type actuator including the iron core 80b and the coil 81b, numeral 83a and 83b denote magnetic pole members formed of a magnetic material to be magnetically attracted and fixedly secured to the elevator car so as to face oppositely to the magnetic attraction type actuators 82a and 82b, respectively, and reference numeral 84a and 84b denote displacement sensors for measuring displacements or gap distances between the rip end of the iron core 80a and the magnetic pole member 83a and between the tip end of the iron core 80b and the magnetic pole member 83b, respectively.

In the vibration damping apparatus now concerned, the magnetic attraction type actuators 82a; 82b are so disposed that the rubber vibration isolators 7 conventionally mounted on the upper portion of the elevator car 1 on the left and right sides, respectively, are sandwiched between the magnetic attraction type actuator 82a and the magnetic pole member 83a and between the magnetic attraction type actuator 82b and the magnetic pole member 83b, respectively.

Operation of the vibration damping apparatus now under consideration is substantially same as the system according to the tenth embodiment of the invention. The rubber vibration isolators 7 and 8 serve for passive vibration suppressing function. When vibration components which can not be suppressed by means of the conventional vibration damping mechanism occur in the elevator car 1, vibration of the floor of the elevator car 1 is detected by the vibration sensor 58 while vibration of the car supporting frame 2 is detected by the vibration sensor 59. Relative displacement between the elevator car 1 and the car supporting frame 2 is detected by the displacement sensors 74a; 74b and 84a; 84b. The output signals of these sensors are supplied to the controller 61 which responds thereto by generating the control command signals for the magnetic attraction type actuators 72a; 72b and 82; 82b, which are then so driven in response to the control command signals as to reduce the vibration level of the floor of the elevator car 1. More specifically, by feeding the driving currents to the coils 71a; 71b and 81a; 81b wound around the iron cores 70a; 70b and 80a ; 80b, magnetic attracting forces are generated for the magnetic pole members 73a; 73b and 83a; 83b, respectively. Since the magnetic pole members 73a; 73b and 83a; 83b are mounted, respectively, under the floor of the elevator car 1 and at the upper portion of the elevator car 1 on the right and left sides, respectively, the elevator car 1 is caused to move leftward or rightward relative to the car supporting frame 2, as viewed in the figure. Thus, the vibration level of the elevator car 1 is reduced or damped.

The vibration damping apparatus according to the instant embodiment of the invention can ensure much enhanced vibration control performance when compared with the vibration damping apparatus according to the tenth embodiment of the invention because the magnetic attraction type actuators 82a and 82b are additionally provided at the upper portion of the elevator car 1 on the left and right sides, respectively. Besides, since the rubber vibration isolator 7 and the magnetic attraction type actuators 82a and 82b as well as the rubber vibration isolator 8 and the magnetic attraction type actuators 72a and 72b are disposed at the same locations, respectively, the space-saving can be realized to another advantage. Thus, there is provided an active vibration control apparatus of high performance which can also ensure high assembling accuracy and reliability.

Embodiment 16

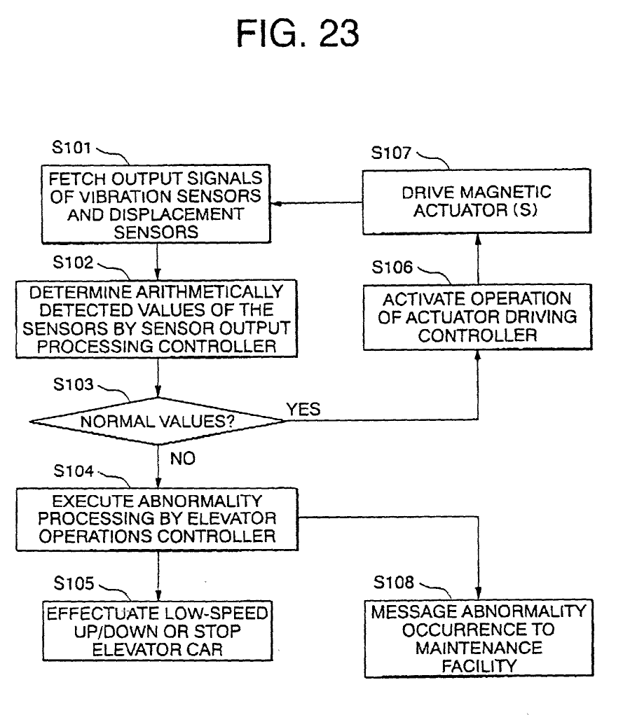

FIG. 23 is a flow chart for illustrating operation of an elevator system equipped with the vibration damping apparatus according to a sixteenth embodiment of the present invention.

The elevator system now concerned may be implemented in the same structure as that of the tenth embodiment of the invention.

Now referring to the flow chart shown in FIG. 23, description will be made of operation of the elevator system according to the instant embodiment of the invention. In the course of the up/down operation of the elevator car performed under control, the output signals of The vibration sensors and the displacement sensors are fetched by a sensor output processing controller (step S101). On the basis of the input signals, the sensor output processing controller arithmetically determines the detection values of the vibration sensors and the displacement sensors, respectively (step S102). Subsequently, on the basis of the results of arithmetic determination, a decision unit incorporated in the sensor output processing controller makes decision as to whether or not the output signals of the vibration sensor and the displacement sensor are normal values (step S103).

When it is decided that the output values of the vibration sensor(s) and the displacement sensor(s) are within a predetermined range of normal values, an actuator driving controller (controller 61 shown in FIG. 16) responds to the result of the decision to generate actuator driving command(s) (step S106) for driving the magnetic attraction type actuators (step S107) Thereafter, the step S101 is resumed for fetching the output signal(s) of the vibration sensor(s) and the displacement sensor(s). Ordinarily, the loop processing described above is executed so long as the elevator operation is normal.

On the other hand, when it is decided that the output signal of the vibration sensor or the displacement sensor lies outside of the predetermined range of normal values, an elevator operation controller executes abnormality processing (step S103). More specifically, the elevator operation controller moves the elevator car at a low speed or alternatively stop the elevator car (step S105). Additionally, the elevator operation controller informs the detection of abnormality to elevator maintenance/inspection facility (step S108). In practical application, the message communication may be effectuated by activating a program prepared to this end.

As is apparent from the above, the vibration damping apparatus for the elevator system according to the instant embodiment of the invention is equipped with the elevator operation controller for operating the elevator car at a low speed or stop the car operation when the output value of the displacement sensor or the vibration sensor exceeds a predetermined range of normal values. Thus, by making decision as to whether the detection values derived from the output(s) of the vibration sensor and/or the displacement sensor exceeds the above-mentioned predetermined range, the elevator operation can be carried out with safety.

Further, the vibration damping apparatus for the elevator system is equipped with the elevator operation controller for issuing massage to the elevator maintenance/inspection facility when the detection value of the displacement sensor or the vibration sensor exceeds the predetermined range mentioned above. Thus, upon occurrence of some abnormality, corresponding message can instantaneously be dispatched to the elevator maintenance/inspection facility, whereby maintenance such as repair or the like of the elevator system can be carried out without delay. In this way, enhanced safety can be ensured for the operation of the elevator system equipped with the vibration damping apparatus for the elevator system according to the sixteenth embodiment of the invention.

Embodiment 17

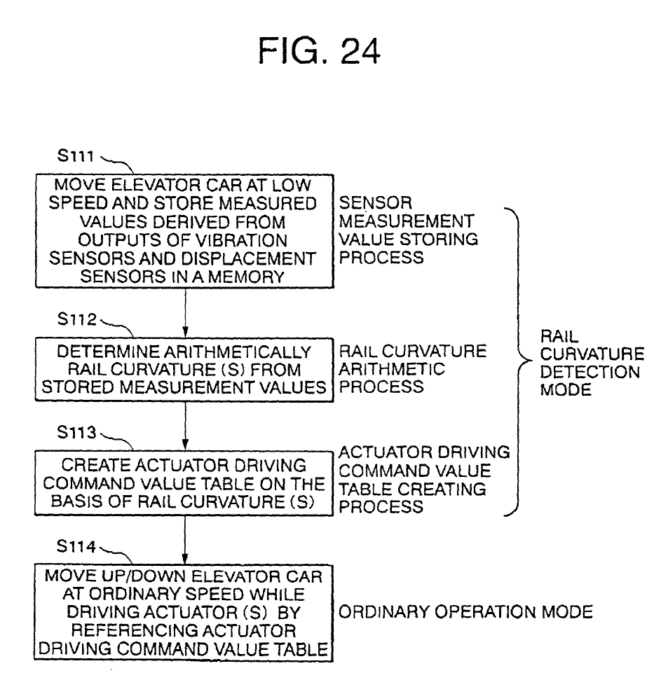

FIG. 24 is a flow chart for illustrating operation of an elevator system equipped with the vibration damping apparatus according to a seventeenth embodiment of the present invention.

The elevator system now concerned may be implemented in the same structure as that of the tenth embodiment of the invention.

Now referring to the flow chart shown in FIG. 24, description will be made of operation of the elevator system according to the instant embodiment of the invention.

In the rail curvature detecting mode, the elevator car is moved up/down at a low speed once or plural times. During this mode, the measured values determined on the basis of the outputs of the vibration sensor and the displacement sensor are fetched to be stored in a memory (step S111). Subsequently, curvatures of the guide rail(s) are arithmetically determined on the basis of the measured value(s) as stored (step S112). Further, the sensor output processing controller prepares or creates a actuator driving command value table on the basis of the rail curvatures mentioned above (step S113).

When the ordinary driving mode is validated in succession to The rail curvature detecting mode, the actuator driving controller allows the up/down operation of the elevator car at an ordinary speed while driving the actuator(s) by referencing the actuator driving command value table created by the sensor output processing controller to thereby carry Out the elevator operation.

As is apparent from the above, the vibration damping apparatus according to the instant embodiment of the invention is equipped with the sensor output processing controller for moving the elevator car at a low speed once or plural times in the rail curvature detecting mode for detecting and storing the rail curvature(s) on the basis of the outputs of the displacement sensor or the vibration sensor, and in the ordinary driving mode, the controller drives the magnetic attraction type actuator (s) by taking into account the curvatures of the rail stored in the memory. Thus, the elevator car operation control can be realized in a feed-forward control fashion, whereby the vibration control for suppressing the vibration brought about by displacement of the car due to curvatures of the guide rails can be performed effectively. There is thus provided the vibration damping apparatus for the elevator system which ensures superhigh-speed up/down operation and excellent comfortableness.

Modifications

Many features and advantages of the present invention are apparent from the derailed description and thus it is intended by the appended claims to cover all such features and advantages of the system which fall within the true spirit and scope of the invention. Further, since numerous modifications and combinations will readily occur to those skilled in the art, it is never intended to limit the invention to the exact construction and operation illustrated and described.

By way of example, the present invention may be carried out with modifications or alterations described below.

(1) In the first to fifth embodiments as well as tenth to fifteenth embodiments, the positional relations between the magnetic actuators and the magnetic pole members are not limited to those illustrated but they can be reversed. In this case, the magnetic attracting forces can be generated through the same method as described hereinbefore for reducing the vibration of the elevator car 1.

(2) In the first to sixth embodiments as well as tenth to fifteenth embodiments, the magnetic actuator is so implemented as to generate the magnetic attracting force for the magnetic pole member. However, the present invention is never restricted to such arrangement. The magnetic actuator may alternatively be so structured as to generate the magnetic repulsive force. In this case, the vibration of the elevator car 1 can equally be reduced as well by changing correspondingly the magnetic actuator(s) to be actuated and positional relationship between or among the magnetic actuators.

In the first to fifteenth embodiments, the vibration sensor is installed on the floor of the elevator car 1 (in the case of the fifth embodiment, the vibration sensor is additionally installed on the ceiling wall of the elevator car 1 as well) and on the bottom member of the car supporting frame 2 (in the case of the fifth embodiment, the vibration sensor is additionally installed on the top member of the car supporting frame 2 as well). However, the positions at which the vibration sensors are to be mounted are not basically limited to any specific locations. In other words, the vibration sensor may be mounted at any appropriate location so far as the vibration of the elevator car 1 can be detected. Accordingly, in the first to fifteenth embodiments, the vibration sensor(s) installed on the bottom member and/or top member of the car supporting frame 2 may be spared. To say in another way, installation of the vibration sensor on the bottom member and/or top member of the car supporting frame 2 in addition or combination to the vibration sensor installed on the floor and/or ceiling wall of the elevator car 1 is certainly meaningful in obtaining lot of information for enhancing the vibration control performance However, unless great importance is put on the vibration control performance, the vibration sensor installed on the bottom member and/or top member of the car supporting frame 2 may be spared with the vibration sensor being mounted only on the floor and/or ceiling wall of the elevator car 1 or alternatively the vibration sensor to be installed on the floor and/or ceiling wall of the elevator car 1 may be spared with a vibration sensor being mounted only on the bottom member and/or top member of the car supporting frame 2 or reversely the vibration sensor mounted on the floor and/or ceiling wall of the elevator car 1 may be spared with the vibration sensor being installed only on the bottom member and/or top member of the car supporting frame 2. In any case mentioned above, the vibration of the floor of the elevator car 1 can be measured by resorting to estimation technique.

(4) In The first to fifteenth embodiments, a plurality of displacement sensors are provided in the same axial direction (e.g in the case of the second embodiment, four displacement sensors 74a, 74b, 74c and 74d are provided in the X-direction). However, there is no necessity of providing all of these displacement sensors. It is sufficient to provide any one of them.

(5) In the eighth and ninth embodiments, the vibration damping apparatus disposed horizontally in the space defined between the lower surface of the floor of the elevator car 1 and the bottom member of the car supporting frame 2 is not restricted to the structure described in conjunction with the second embodiment but the vibration damping apparatus according to the other embodiments may be made use of.

Accordingly, all suitable modifications and equivalents may be resorted to, falling within the spirit and scope of the invention.

1. A vibration damping apparatus for an elevator system including an elevator car and a car supporting frame for supporting said elevator car through the medium of vibration isolation means interposed between said elevator car and said car supporting frame, comprising:
magnetic actuator means disposed within a space defined between a floor of said elevator car and a bottom member of said car supporting frame and fixedly secured to either one of said elevator car or said car supporting frame;
magnetic pole means disposed within said space and fixedly secured to the other one of said elevator car and said car supporting frame and disposed in opposition to said magnetic actuator means so that a magnetic attracting force is generated in a horizontal direction between said magnetic actuator means and said magnetic pole means when a driving current is fed to said magnetic actuator means;
vibration sensor means for detecting vibration of said floor of said elevator car in the horizontal direction; and
controller means for fetching a detection signal of said vibration sensor means as an input signal to thereby control driving of said magnetic actuator means such that vibration of said elevator car in the horizontal direction is thereby reduced.

2. A vibration damping apparatus according to claim 1, wherein an upper space is defined between a ceiling of said elevator car and a top member of said car supporting frame,
further comprising:
magnetic actuator means disposed within said upper space and fixedly secured to either one of said elevator car or said car supporting frame;
magnetic pole means disposed within said upper space and fixedly secured to the other one of said elevator car and said car supporting frame and disposed in opposition to said magnetic actuator means so that magnetic attracting forces are generated in a horizontal direction between said magnetic actuator means and said magnetic pole means when driving currents are fed to said magnetic actuator means;
vibration sensor means for detecting vibrations of said ceiling of said elevator car in the horizontal direction; and
controller means for fetching detection signals of said vibration sensor means as input signals to thereby control driving of said magnetic actuator means such that vibration of said elevator car in the horizontal direction is thereby reduced.

3. A vibration damping apparatus for an elevator system according to claim 1,
wherein said magnetic actuator means is constituted by a magnetic attraction type actuator designed for generating an electromagnetic attracting force.

4. A vibration damping apparatus for an elevator system according to claim 3,
wherein said apparatus further comprises:
cushioning means disposed between said magnetic actuator and said magnetic pole means.

5. A vibration damping apparatus for an elevator system according to claim 4,
wherein said cushioning means is disposed on an end face of said magnetic pole means which faces in opposition to said magnetic attraction type actuator.

6. A vibration damping apparatus for an elevator system according to claim 4,
wherein said cushioning means is disposed on an attracting end face of a coil-wound core of said magnetic attraction type actuator which face is disposed in opposition to said magnetic pole means.

7. A vibration damping apparatus for an elevator system according to claim 3,
wherein said magnetic actuator means includes a plurality of magnetic attraction type actuators which are so combined with one another that forces can be generated along two translation axes and around one rotation axis, respectively.

8. A vibration damping apparatus for an elevator system according to claim 3,
wherein said magnetic actuator means includes a plurality of magnetic attraction type actuators which are combined pairwise in sets oriented orthogonally to each other so that a couple of forces can be generated around a center of suspension of said car supporting frame, whereby forces can be generated along two translation axes and around one rotation axis, respectively.

9. A vibration damping apparatus for an elevator system according to claim 3, wherein said controller means is so designed as to fetch as input signals thereto a detection signal of displacement sensor means designed for measuring a gap between a coil-wound core of said magnetic attraction type actuator together with said magnetic pole means and a detection signal of said vibration sensor to thereby generate a control signal for driving said magnetic attraction type actuator.

10. A vibration damping apparatus for an elevator system according to claim 3,
wherein said magnetic attraction type actuator includes coils wound around an annular iron core and magnetically attracts said magnetic pole means disposed in opposition to said coils upon electrical energization thereof.

11. A vibration damping apparatus for an elevator system according to claim 9,
herein said displacement sensor means is so fixedly secured to said magnetic attraction type actuator as to present a reference face positioned in a same plane as an attracting end face of said coil-wound core of said magnetic attraction type actuator.

12. A vibration damping apparatus for an elevator system according to claim 9,
wherein said displacement sensor means is so fixedly secured to said magnetic pole means as to present a reference face positioned in a same plane as an end face of said magnetic pole means which is disposed in opposition to said magnetic attraction type actuator.

13. A vibration damping apparatus for an elevator system including an elevator car and a car supporting frame for supporting said elevator car through the medium of vibration isolation means interposed between said elevator car and said car supporting frame, wherein a space is defined between a floor of said elevator car and a bottom member of said car supporting frame, comprising:
magnetic actuator means including plural pairs of magnetic actuators disposed within said space, each of said magnetic actuators being designed to generate selectively a magnetic attracting force or a magnetic repulsive force, wherein ones of said paired magnetic actuators being fixedly secured to either one of said elevator car or said car supporting frame while the others of said paired magnetic actuators are fixedly secured to the other one of said elevator car and said car supporting frame, said magnetic actuators in each of said pairs being disposed in opposition to each other,
vibration sensor means for detecting vibration of said floor of said elevator car in horizontal direction; and
controller means for fetching a detection signal of said vibration sensor means as an input signal to thereby selectively control driving of said pairs of magnetic actuator means such that vibration of said elevator car in the horizontal direction can thereby be reduced.

14. A vibration damping apparatus for an elevator system according to claim 1,
wherein vibration isolation means is disposed between said magnetic attraction type actuator and said magnetic pole means.

15. A vibration damping apparatus for an elevator system according to claim 1,
further comprising:
an elevator operation controller which is designed to perform up/down operation of said elevator car at a low speed or stop the up/down operation of said elevator car when an output value of said vibration sensor exceeds a range of predetermined values.

16. A vibration damping apparatus for an elevator system according to claim 1,
further comprising:
an elevator operation controller which informs an elevator maintenance/inspection facility of occurrence of abnormality when an output value of said vibration sensor exceeds a range of predetermined values.

17. A vibration damping apparatus for an elevator system according to claim 1,
further comprising:
a sensor output processing controller means which is designed to carry out up/down operation of said elevator car at a low speed once or several times for detecting and storing rail curvatures on the basis of output of said vibration sensor,
wherein in an ordinary operation mode, said controller means drives said magnetic actuator means by taking into account said stored rail curvature(s).

18. A vibration damping apparatus for an elevator system including an elevator car and guide rails disposed at lateral sides of said elevator car,
further comprising:
magnetic guide means including a set of magnetic attraction type actuators for holding said elevator car in a contactless state by generating magnetic attracting forces to said guide rails, respectively;
displacement sensor means for detecting positional displacements or deviations of said guide rails; and
controller means for fetching as input signals thereto detection signals derived from outputs of said displacement sensor means to thereby generate control signals to said set of magnetic attraction type actuators for thereby reducing vibration of said elevator car in horizontal direction.

19. An elevator system including an elevator car and a car supporting frame for supporting said elevator car through the medium of vibration isolation means interposed between said elevator car and said car supporting frame, comprising:
magnetic actuator means disposed within a space defined between a floor of said elevator car and a bottom member of said car supporting frame and fixedly secured to either one of said elevator car or said car supporting frame;
magnetic pole means disposed within said space and fixedly secured to the other one of said elevator car and said car supporting frame and disposed in opposition to said magnetic actuator means so that a magnetic attracting force is generated in a horizontal direction between said magnetic actuator means and said magnetic pole means when a driving current is fed to said magnetic actuator means;
vibration sensor means for detecting vibration of said floor of said elevator car in the horizontal direction;
guide rails disposed at lateral sides of said car supporting frame for guiding up/down movement of said car supporting frame and said elevator car;
magnetic guide means including a set of magnetic attraction type actuators for holding said car supporting frame in a contactless state by generating magnetic attracting forces to said guide rails;
displacement sensor means for detecting positional displacements or deviations of said guide rails; and
controller means for fetching as input signals thereto detection signals derived from outputs of said vibration sensor means and said displacement sensor means to thereby generate control signals to said magnetic actuation means and said magnetic guide means for thereby reducing vibration of said elevator car in horizontal direction.

20. A vibration damping apparatus for an elevator system according to claim 19,
wherein said guide rail is of a V- or T-like cross section.
